(19) United States
(12) Patent Application Publication
(10) Pub. No.: US 2024/0319936 A1
(43) Pub. Date: Sep. 26, 2024

(54) RELAY SERVER, PRINTING SYSTEM, INFORMATION PROCESSING METHOD, AND NON-TRANSITORY COMPUTER-READABLE STORAGE MEDIUM STORING PROGRAM

(71) Applicant: SEIKO EPSON CORPORATION, Tokyo (JP)

(72) Inventor: Yasuhiro FURUTA, SHIMOSUWA-MACHI (JP)

(21) Appl. No.: 18/612,765

(22) Filed: Mar. 21, 2024

(30) Foreign Application Priority Data
Mar. 24, 2023 (JP) 2023-047702

(51) Int. Cl. G06F 3/12; G06Q 30/0283

(52) U.S. Cl. CPC G06F 3/1238; G06F 3/1222; G06F 3/1273; G06F 3/1288; G06Q 30/0283

(57) ABSTRACT

A relay server 300 according to an aspect of the present disclosure includes an authentication controller 331 that acquires authentication completion information indicating that a first printing service system 100 completes authentication, a printing controller 335 that acquires printing job information from the first printing service system 100 and transmits a request to cause an image forming device 600 to execute printing for the printing job information to a second printing service system 200, a storage 310 that acquires job state information corresponding to the printing job information from the second printing service system 200 and stores printing history information corresponding to the job state information, and a printing history information acquisition unit that acquires printing history information on the image forming device 600 from the storage 310. The printing history information includes external user information that is information on a user belonging to an organization different from an organization to which the image forming device 600 belongs.

The present application is based on, and claims priority from JP Application Serial Number 2023-047702, filed Mar. 24, 2023, the disclosure of which is hereby incorporated by reference herein in its entirety.

### BACKGROUND

### 1. Technical Field

The present disclosure relates to a relay server, a printing system, an information processing method, and a non-transitory computer-readable storage medium storing a program.

### 2. Related Art

A technique of performing printing using a printer connected to a network is known. For example, JP-A-2022-038375 discloses a printing system implemented by combining different systems on a network, specifically, a printing system implemented by combining a first cloud printing service system and a second cloud printing service system. The printing system further includes a cloud printing management service system that serves as a bridge between the first cloud printing service system and the second cloud printing service system. The cloud printing management service system associates a virtual printer registered in the first cloud printing service system with a printing device registered in the second cloud printing service system, thereby enabling printing performed by the printing device via the first cloud printing service system and the second cloud printing service system.

JP-A-2022-038375 is an example of the related art.

### SUMMARY

A technique for preventing unauthorized use of a system is required to be introduced in a printing system using a printer connected to a network. In the technique disclosed in JP-A-2022-038375, a server requests input of authentication information in order to check whether a user has a valid authority. Printing requiring authentication in this manner is hereinafter also referred to as “authentication printing” in the present disclosure. Unauthorized use of the system can be prevented by the authentication printing.

Such a printing system is assumed to be used by a user in a specific organization, but, for example, the convenience of the printing system is improved by permitting the use by an external user. However, when the external user is permitted to use the printing system, it is required to charge the external user for a printing cost, and the work of charging a cost may be complicated. Therefore, there is a demand for a technique capable of easily charging an external user for a printing cost when the external user uses the printing system.

A relay server according to an aspect of the present disclosure is a relay server coupled to a first printing service system and a second printing service system that is coupled to an image forming device. The relay server includes: an authentication control unit configured to acquire authentication completion information indicating that the first printing service system completes authentication for user authentication information input to a terminal device; a printing control unit configured to acquire user information from the first printing service system based on the authentication completion information, acquire printing job information corresponding to the user information from the first printing service system, and transmit, to the second printing service system, a request to cause the image forming device to execute printing for the printing job information; a storage unit configured to acquire job state information corresponding to the printing job information from the second printing service system, and store printing history information corresponding to the job state information; and a printing history information acquisition unit configured to acquire printing history information on the image forming device from the storage unit. The printing history information includes external user information that is information on a user belonging to an organization different from an organization to which the image forming device belongs.

A printing system according to an aspect of the present disclosure includes a first printing service system, an image forming device, a second printing service system coupled to the image forming device, and a relay server coupled to the first printing service system and the second printing service system. The relay server includes: an authentication control unit configured to acquire authentication completion information indicating that the first printing service system completes authentication for user authentication information input to a terminal device; a printing control unit configured to acquire user information from the first printing service system based on the authentication completion information, acquire printing job information corresponding to the user information from the first printing service system, and transmit, to the second printing service system, a request to cause the image forming device to execute printing for the printing job information; a storage unit configured to acquire job state information corresponding to the printing job information from the second printing service system, and store printing history information corresponding to the job state information; and a printing history information acquisition unit configured to acquire printing history information on the image forming device from the storage unit. The printing history information includes external user information that is information on a user belonging to an organization different from an organization to which the image forming device belongs.

An information processing method according to an aspect of the present disclosure is an information processing method performed by a relay server coupled to a first printing service system and a second printing service system that is coupled to an image forming device. The information processing method includes: an authentication control step of acquiring authentication completion information indicating that the first printing service system completes authentication for user authentication information input to a terminal device; a printing control step of acquiring user information from the first printing service system based on the authentication completion information, acquiring printing job information corresponding to the user information from the first printing service system, and transmitting, to the second printing service system, a request to cause the image forming device to execute printing for the printing job information; a storage step of acquiring job state information corresponding to the printing job information from the second printing service system, and storing printing history information corresponding to the job state information; and a printing history information acquisition step of acquiring the stored printing history information on the image forming device. The printing history information includes external user information that is information on a user belonging to an organization different from an organization to which the image forming device belongs.

According to an aspect of the present disclosure, provided is a non-transitory computer-readable storage medium storing a program. The program causes a computer in a relay server coupled to a first printing service system and a second printing service system that is coupled to an image forming device to execute steps including: an authentication control step of acquiring authentication completion information indicating that the first printing service system completes authentication for user authentication information input to a terminal device; a printing control step of acquiring user information from the first printing service system based on the authentication completion information, acquiring printing job information corresponding to the user information from the first printing service system, and transmitting, to the second printing service system, a request to cause the image forming device to execute printing for the printing job information; a storage step of acquiring job state information corresponding to the printing job information from the second printing service system, and storing printing history information corresponding to the job state information; and a printing history information acquisition step of acquiring the stored printing history information on the image forming device. The printing history information includes external user information that is information on a user belonging to a second organization different from a first organization to which the image forming device belongs.

### BRIEF DESCRIPTION OF THE DRAWINGS

FIG. 1 is a block diagram showing an example of a configuration of a printing system according to an embodiment.

FIG. 2 is a block diagram showing an example of a configuration of a first printing service system according to the embodiment.

FIG. 3 is a block diagram showing an example of a configuration of a second printing service system according to the embodiment.

FIG. 4 is a block diagram showing an example of a configuration of a relay server according to the embodiment.

FIG. 5 is a block diagram showing an example of a configuration of a first terminal device according to the embodiment.

FIG. 6 is a block diagram showing an example of a configuration of a second terminal device according to the embodiment.

FIG. 7 is a block diagram showing an example of a configuration of an image forming device according to the embodiment.

FIG. 8A is a sequence chart showing an example of a flow of a code virtual printer registering process.

FIG. 8B is a sequence chart showing the example of the flow of the code virtual printer registering process.

FIG. 9 is a sequence chart showing an example of a flow of an external user information request setting process.

FIG. 10 is a sequence chart showing an example of a flow of an external printer usage information provision setting process.

FIG. 11 is a sequence chart showing an example of a flow of a process of receiving printing data by the printing system.

FIG. 12A is a sequence chart showing an example of a flow of a printing process.

FIG. 12B is a sequence chart showing an example of the flow of the printing process.

FIG. 12C is a sequence chart showing an example of the flow of the printing process.

FIG. 12D is a sequence chart showing an example of the flow of the printing process.

FIG. 12E is a sequence chart showing an example of the flow of the printing process.

FIG. 12F is a sequence chart showing an example of the flow of the printing process.

FIG. 12G is a sequence chart showing an example of the flow of the printing process.

FIG. 12H is a sequence chart showing an example of the flow of the printing process.

FIG. 12I is a sequence chart showing an example of the flow of the printing process.

FIG. 13 is a sequence chart showing an example of a flow of a printer use history acquisition process.

### DESCRIPTION OF EMBODIMENTS

Hereinafter, embodiments will be described with reference to the drawings. To clarify the description, the following description and drawings are omitted and simplified as appropriate. In the drawings, the same elements are denoted by the same reference signs, and redundant description thereof is omitted as necessary.

When different systems providing printing services cooperate with each other, authentication printing is preferably implemented in order to prevent printing from being performed by unauthorized use of the systems. The embodiment first describes a technique for implementing authentication printing in a printing system in which different systems providing printing services cooperate with each other. Therefore, the embodiment describes a technique in which a user designates an image forming device to be used for printing using a code image attached to the image forming device in the printing system in which different systems providing printing services cooperate with each other.

Such a printing system is assumed to be used by a user in a specific organization, but, for example, the convenience of the printing system is improved by permitting the use by an external user. However, when the external user is permitted to use the printing system, it is required to charge the external user for a printing cost, and the work of charging a cost may be complicated. The embodiment also describes a technique capable of easily charging an external user for a printing cost when the external user uses the printing system.

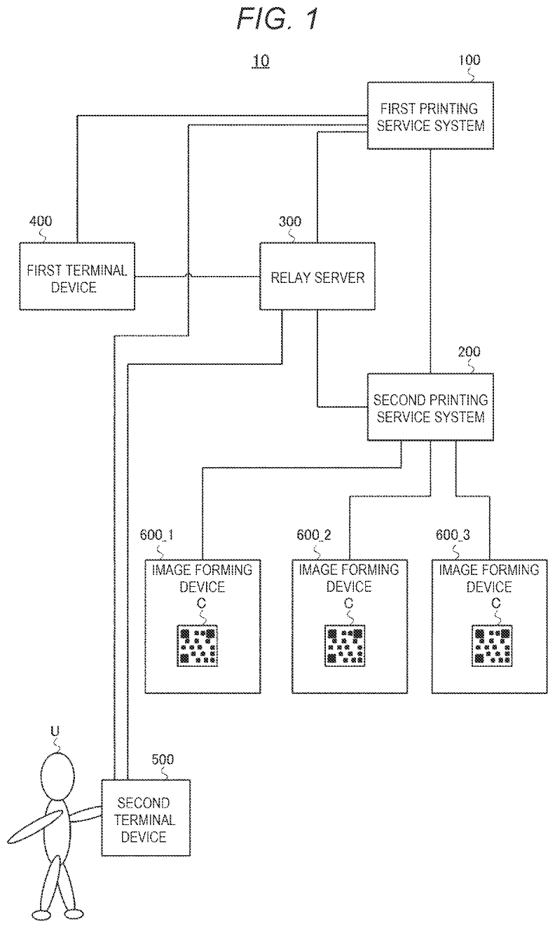

FIG. 1 is a block diagram showing an example of a configuration of a printing system 10 according to an embodiment. The printing system 10 includes a first printing service system 100, a second printing service system 200, and a relay server 300. FIG. 1 also shows a first terminal device 400, a second terminal device 500, and image forming devices 600_1, 600_2, and 600_3 that are communicably connected to the printing system 10. In the following description, the image forming devices 600_1, 600_2, and 600_3 are referred to as image forming devices 600 when they are not particularly distinguished. FIG. 1 also shows a user U who carries the second terminal device 500 and moves to the front of the image forming devices 600 to be used.

A system including the first terminal device 400 may be referred to as the printing system 10. Similarly, a system including the second terminal device 500 may be referred to as the printing system 10, and a system including the image forming device 600 may be referred to as the printing system 10.

The first printing service system 100 and the second printing service system 200 are systems that provide printing services on a cloud. Here, the first printing service system 100 is a system for services provided by a first vendor, and the second printing service system 200 is a system for services provided by a second vendor different from the first vendor. For example, the second vendor is a vendor that produces the image forming device 600.

The image forming device 600 is a device having a function of performing a printing process. In the embodiment, the image forming device 600 is specifically a printer. In the embodiment, the image forming device 600 is registered in the second printing service system 200 in advance as a device capable of executing a printing process for a printing job managed by the second printing service system 200.

The first terminal device 400 and the second terminal device 500 are client terminals such as personal computers (PCs), smartphones, and tablet terminals. In particular, the second terminal device 500 is preferably a mobile terminal that can be easily carried by the user U. The first terminal device 400 and the second terminal device 500 may be the same terminal device.

The relay server 300 is a server that bridges the first printing service system 100 and the second printing service system 200, and relays a process in the printing system 10.

A code image C is attached to the image forming device 600. The code image C includes at least identification information for uniquely identifying the image forming device 600. In the embodiment, the code image C further includes information indicating a predetermined access destination. Specifically, the information indicating the predetermined access destination is, for example, a uniform resource locator (URL) for accessing the relay server 300. The code image C may be an image obtained by encoding the above-described information, a bar code, or a two-dimensional code such as a QR code (registered trademark). The code image C attached to the image forming device 600 that the user U wants to use is read by the second terminal device 500 by an operation performed by the user U.

In the embodiment, the image forming device 600 is a device managed by a specific organization. That is, the image forming device 600 is a device belonging to a specific organization. The image forming devices 600 may be managed by different organizations. For example, the image forming devices 600_1 and 600_2 may be managed by an organization A, and the image forming device 600_3 may be managed by an organization B. In the following description, in order to simplify the description, it is assumed that the image forming devices 600_1 to 600_3 are managed by the same organization.

As shown in FIG. 1, the first printing service system 100 and the second printing service system 200 are communicably connected to each other. The relay server 300 is communicably connected to each of the first printing service system 100 and the second printing service system 200. The image forming device 600 is communicably connected to the second printing service system 200. The first terminal device 400 and the second terminal device 500 each are communicably connected to at least the first printing service system 100 and the relay server 300. In addition to the above-described connection relationship, a further connection relationship may be present between the components. For example, the first terminal device 400 and the second terminal device 500 may be communicably connected to the second printing service system 200.

In FIG. 1, three image forming devices 600 are shown as an example, but the number of image forming devices 600 using the printing system 10 is any value. Similarly, one first terminal device 400 and one second terminal device 500 are shown as an example, and the number of the first terminal devices 400 and the second terminal devices 500 using the printing system 10 is any value.

As described above, both the first printing service system 100 and the second printing service system 200 are systems that provide printing services on a cloud. Therefore, when a printer is registered in the printing service system, the printer can perform printing via the printing service system. However, when the printer is not a model that supports a protocol used by the printing service system, the printer cannot be directly registered in the printing service system. In the embodiment, the image forming device 600 supports a protocol used by the second printing service system 200, and can be directly registered in the second printing service system 200. However, the image forming device 600 does not necessarily support a protocol used by the first printing service system 100.

Therefore, in the embodiment, a printer registered as a virtual printer (virtual device) in the first printing service system 100 is associated with the image forming device 600 registered in the second printing service system 200, thereby performing printing by the image forming device 600 via the first printing service system 100. The association is performed by the relay server 300. Although the image forming device 600 is a model that does not support the protocol of the first printing service system 100, the user may desire printing performed by the image forming device 600 using the printing service provided by the first printing service system 100. Examples of such a case include a case in which installation of a printer driver of the image forming device 600 required in the second printing service system 200 is not required in the first printing service system 100. Of course, the user may desire printing performed by the image forming device 600 using the first printing service system 100 for any other reason. In such a case, the relay server 300 is required to associate the image forming device 600 registered in the second printing service system 200 with the virtual printer registered in the first printing service system 100. The first printing service system 100 provides a printing service using, for example, internet printing protocol shared infrastructure extensions (IPP-Infra) as the above-described protocol, whereas the second printing service system 200 provides a printing service without using the protocol.

In the embodiment, the user U moves to the front of an image forming device 600 and reads a code image C attached to the image forming device 600 by the second terminal device 500, thereby designating the image forming device 600 used by the user U for printing. That is, in the embodiment, an output destination of a printed matter is designated by reading the code image C. Therefore, in the embodiment, as described later, the relay server 300 registers, in the first printing service system 100 in advance, a dedicated virtual printer for a printing job in which an output destination is designated by reading the code image C. When the code image C is read, the dedicated virtual printer is associated with the image forming device 600 specified from the read code image C.

In the embodiment, as described later, the relay server 300 requires authentication completion information indicating that authentication of the user U performed by the first printing service system 100 is completed as a condition for processing a printing request from the user U. Accordingly, the authentication printing is implemented in the printing system 10 in which different systems providing the printing services cooperate with each other.

Hereinafter, a specific configuration and process of the printing system 10 will be described. The configurations of the first printing service system 100, the second printing service system 200, the relay server 300, the first terminal device 400, the second terminal device 500, and the image forming device 600 will be described with reference to the drawings.

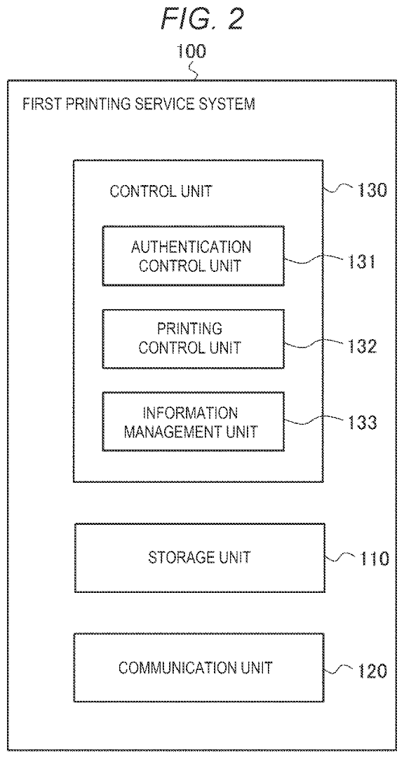

FIG. 2 is a block diagram showing an example of the configuration of the first printing service system 100. In the example shown in FIG. 2, the first printing service system 100 is implemented by one server, and the first printing service system 100 may be implemented by a plurality of servers.

As shown in FIG. 2, the first printing service system 100 includes a storage unit 110, a communication unit 120, and a control unit 130.

The storage unit 110 is a storage device that stores a program for implementing a process performed by the control unit 130 and data used for a process performed by the first printing service system 100. The storage device may be a nonvolatile storage device such as a hard disk or a flash memory, or may include a memory such as a random access memory (RAM). The storage unit 110 may also include a database. The communication unit 120 is a communication interface for communicating with other devices such as the second printing service system 200, the relay server 300, the first terminal device 400, and the second terminal device 500 via a wireless network or a wired network. The control unit 130 is a processor such as a central processing unit (CPU) that controls the components of the first printing service system 100. The control unit 130 may include a plurality of processors. The control unit 130 reads a program into the memory and executes the program. Accordingly, the control unit 130 implements functions of an authentication control unit 131, a printing control unit 132, and an information management unit 133.

The authentication control unit 131 performs various processes related to authentication of a user who uses the first printing service system 100. The user of the first printing service system 100 includes a user who is an administrator and a user who is a general user not an administrator. The user who is an administrator can also be referred to as a user who has administrator authority. The user who is a general user may be referred to as a user who has user authority that is authority more limited than the administrator authority. In the embodiment, it is assumed that a user is registered in advance in the first printing service system 100. The authentication control unit 131 provides a page for authentication to the first terminal device 400 or the second terminal device 500, performs authentication of an administrator or a general user, and issues a token required for accessing the first printing service system 100. A specific process performed by the authentication control unit 131 in the embodiment will be described using a sequence chart to be described later.

The printing control unit 132 performs a control process for executing printing by the printer registered in the first printing service system 100. In the embodiment, the printing control unit 132 performs a control process for performing printing by the image forming device 600 via the virtual printer registered in the first printing service system 100, and the printing control unit 132 may perform a control process for performing printing by a physical printer registered directly, not as a virtual printer, in the first printing service system 100. Specifically, in the embodiment, the printing control unit 132 performs a process of receiving a printing request from the first terminal device 400, a process of transmitting information required for performing printing according to the printing request to the relay server 300, a process of notifying the first terminal device 400 or the second terminal device 500 of a job state, and the like. A specific process performed by the printing control unit 132 in the embodiment will be described using a sequence chart to be described later.

The information management unit 133 performs a process of registering a printer for the first printing service system 100. The information management unit 133 manages information on a user registered in the first printing service system 100. The information on the user includes, for example, authentication information on the user and identification information (organization ID) on a user organization which is an organization to which the user belongs. The information on the user includes external user information. The external user information is information on a user belonging to an organization different from an organization to which the image forming device 600 belongs. In the embodiment, the organization to which the image forming device 600 belongs is referred to as a first organization, and the organization to which the external user belongs is referred to as a second organization.

The authentication information on the user includes identification information on the user (a user ID) and verification information such as a password or a personal identification number. The information management unit 133 may manage information on a printer registered in the first printing service system 100. For example, the information management unit 133 may manage a printer name, a printer ID, capability information, shared information, and the like of the registered printer. The information management unit 133 may further perform a process of registering a user in the first printing service system 100. A specific process performed by the information management unit 133 in the embodiment will be described using a sequence chart to be described later.

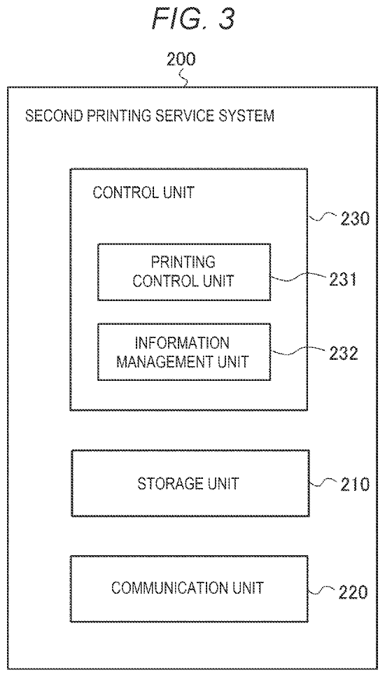

FIG. 3 is a block diagram showing an example of a configuration of the second printing service system 200. In the example shown in FIG. 3, the second printing service system 200 is implemented by one server, and the second printing service system 200 may be implemented by a plurality of servers.

As shown in FIG. 3, the second printing service system 200 includes a storage unit 210, a communication unit 220, and a control unit 230.

The storage unit 210 is a storage device that stores a program for implementing a process performed by the control unit 230 and data used for a process performed by the second printing service system 200. The storage device may be a nonvolatile storage device such as a hard disk or a flash memory, and may include a memory such as a RAM. The storage unit 210 may also include a database. The communication unit 220 is a communication interface for communicating with other devices such as the first printing service system 100, the relay server 300, and the image forming device 600 via a wireless network or a wired network. The control unit 230 is a processor, such as a CPU, that controls components of the second printing service system 200. The control unit 230 may include a plurality of processors. The control unit 230 reads a program into the memory and executes the program. Accordingly, the control unit 230 implements functions of a printing control unit 231 and an information management unit 232.

The printing control unit 231 performs a control process for executing printing by the image forming device 600 that is a printer registered in the second printing service system 200. Specifically, in the embodiment, the printing control unit 231 performs a process of receiving a printing request from the relay server 300, a process of transmitting information required for printing according to the printing request to the image forming device 600, a process of notifying the relay server 300 of a job state, and the like. A specific process performed by the printing control unit 231 in the embodiment will be described using a sequence chart to be described later.

The information management unit 232 manages information registered in the second printing service system 200. For example, the information management unit 232 manages information on the image forming device 600 that is a printer registered in the second printing service system 200. The information management unit 232 may manage attribute information on the registered image forming device 600, such as a printer name and capability information, as information on the image forming device 600, that is, information on the printer. The information management unit 232 may perform a process of registering the image forming device 600 in the second printing service system 200.

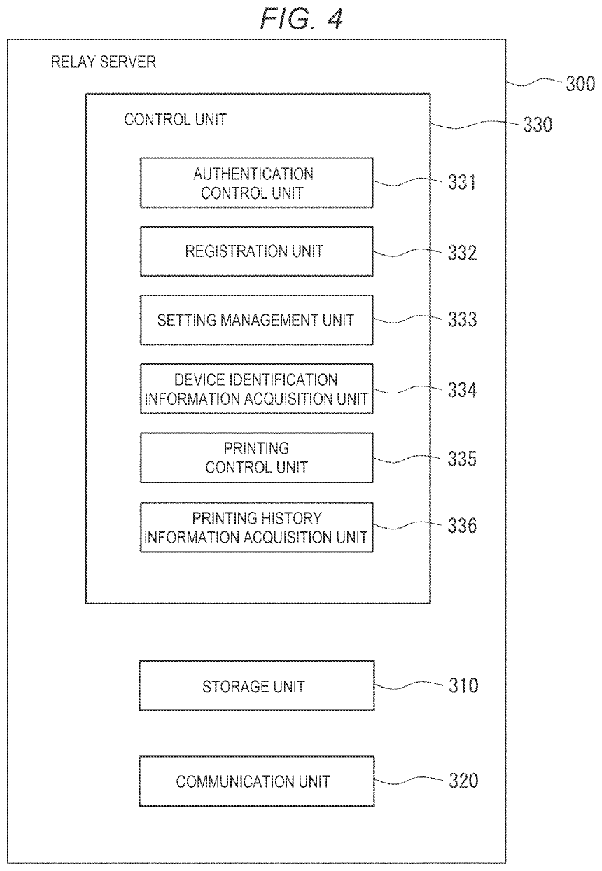

FIG. 4 is a block diagram showing an example of a configuration of the relay server 300. In the example shown in FIG. 4, the relay server 300 is implemented by one server, and the relay server 300 may be implemented by a plurality of servers. The relay server 300 may be referred to as a server.

As shown in FIG. 4, the relay server 300 includes a storage unit 310, a communication unit 320, and a control unit 330.

The storage unit 310 is a storage device that stores a program for implementing a process performed by the control unit 330 and data used for a process performed by the relay server 300. The storage device may be a nonvolatile storage device such as a hard disk or a flash memory, and may include a memory such as a RAM. The storage unit 310 may also include a database. The storage unit 310 stores, for example, a correspondence relationship between the virtual printer and the image forming device 600, setting information on use of the image forming device 600, a correspondence relationship between a printing job of the first printing service system 100 and a printing job of the second printing service system 200, and printing history information corresponding to job state information acquired from the second printing service system 200. The printing history information includes, for example, a printing completion time point, a printer ID, the number of printed pages, and the external user information. The setting information on the use of the image forming device 600 includes a rule related to the use of the image forming device 600 that is predetermined by an administrator or the like. The setting information on the use of the image forming device 600 may include a user instruction related to application of the above-described rule. The storage unit 310 may store different rules for each user organization. The storage unit 310 may store different instructions for each user.

The communication unit 320 is a communication interface for communicating with other devices such as the first printing service system 100, the second printing service system 200, the first terminal device 400, and the second terminal device 500 via a wireless network or a wired network. The control unit 330 is a processor, such as a CPU, that controls components of the relay server 300. The control unit 330 may include a plurality of processors. The control unit 330 reads a program into the memory and executes the program. Accordingly, the control unit 330 implements functions of an authentication control unit 331, a registration unit 332, a setting management unit 333, a device identification information acquisition unit 334, a printing control unit 335, and a printing history information acquisition unit 336.

The authentication control unit 331 performs various processes for receiving authentication performed by the first printing service system 100. In particular, the authentication control unit 331 performs a process of acquiring the authentication completion information. Here, the authentication completion information is information indicating that the authentication performed by the first printing service system 100 for the authentication information on the user input to the first terminal device 400 or the second terminal device 500 is completed. In the embodiment, the authentication completion information is, specifically, a token (hereinafter, referred to as an access token) required for accessing the first printing service system 100. A specific process performed by the authentication control unit 331 in the embodiment will be described using a sequence chart to be described later.

The registration unit 332 performs a process of registering a virtual printer (virtual device) in the first printing service system 100. In particular, in order to enable designation of the output destination by reading the code image C, the registration unit 332 registers, in the printing system 10 in which different systems providing printing services cooperate with each other, a dedicated virtual printer for a printing job in which an output destination is designated by reading the code image C. Hereinafter, such a virtual printer is referred to as a code virtual printer.

The image forming device 600 associated with the code virtual printer is changed depending on the code image C of which image forming device 600 the user reads with the second terminal device 500. The association of the image forming device 600 with the code virtual printer is temporary, and a new association is set every time a printing operation is performed, that is, every time the output destination is designated using the code image C. Therefore, the code virtual printer can also be referred to as a virtual printer that can be associated with any image forming device 600. The association between the code virtual printer and the image forming device 600 is performed by the printing control unit 335, as described later. Instead of designating the image forming device 600 as the output destination using the code image C, a virtual printer registered in the first printing service system 100 may be fixedly associated with any image forming devices 600 such that an output by the specific image forming device 600 can be designated when requesting the first printing service system 100 to perform printing.

In the embodiment, the first printing service system 100 performs a virtual printer registering process only in response to a registration request with administrator authority, and does not permit registration in response to a registration request without administrator authority. Therefore, the registration unit 332 performs the process of registering the virtual printer in the first printing service system 100 using qualification information corresponding to the administrator authority. As described above, in the embodiment, the administrator authority is required to execute the registration process, and the administrator authority is not necessarily required. A specific process performed by the registration unit 332 in the embodiment will be described using a sequence chart to be described later.

The setting management unit 333 performs a process of managing a setting related to the use of the image forming device 600. The setting management unit 333 generates a rule related to the use of the image forming device 600 based on an instruction from a user as an administrator. The rule is generated for each user organization based on an instruction from an administrator of the organization. Therefore, the setting management unit 333 generates a different rule for each user organization. The rule is generated for each image forming device 600 for each user organization. That is, the rule related to the use is set for each user organization and for each image forming device 600. The administrator may instruct that a common rule is generated for all image forming devices 600 managed by the same organization. That is, the rule related to the use may be set for each organization that manages the image forming device 600. The setting management unit 333 stores the generated rule in the storage unit 310 as setting information on the use of the image forming device 600.

In the embodiment, the setting management unit 333 performs a process of managing a setting related to the use of the image forming device 600 by an external user. Specifically, the setting management unit 333 manages, based on an instruction from a first administrator of the first organization who manages the image forming device 600, the setting related to the use of the image forming device 600 by the external user. The external user is a user belonging to the second organization different from the first organization to which the image forming device 600 belongs.

The first administrator of the first organization may set, according to the above rule, a rule when the external user uses the image forming device 600. The first administrator of the first organization may set request information to be requested from the external user when the external user uses the image forming device 600, and may determine, based on the request information, information to be provided by the external user. The process is also referred to as an “external user information request setting”.

For example, when the external user uses the image forming device 600, the first administrator of the first organization may set what information to be requested as the external user information. Here, the external user information is information used for an administrator of the first organization to which the image forming device 600 belongs to charge the external user for a cost when the external user uses the image forming device 600. The external user information is information by which an external user can be uniquely identified, and includes, for example, a user ID and an email address. As the external user information, information obtained by combining a unique value (such as UUID) and an organization ID in the organization to which the external user belongs may be used. The external user information may be information by which the organization to which the external user belongs can be uniquely identified, and an organization ID, a domain name, or the like can be used in this case.

For example, the first administrator may use the first terminal device 400 to manage the setting related to the use of the image forming device 600 by the external user. For example, the relay server 300 may transmit setting screen information for setting the request information to the first terminal device 400 and receive the request information input to the first terminal device 400. The first terminal device 400 is also referred to as a first management device.

A second administrator of the second organization to which the external user belongs may set information that can be provided when the external user uses the external image forming device 600. That is, the second administrator may set provision of personal information used for authentication of the external user. The process is also referred to as an “external printer usage information provision setting”.

For example, the second administrator may set availability of provision for each type of the above-described external user information. For example, the second administrator may use a second management device to set information that can be provided when the external user uses the external image forming device 600. For example, the relay server 300 may transmit setting screen information for setting provision of personal information used for authentication of the external user to the second management device, and may receive provision setting information input to the second management device. For example, the second management device is a management device managed by the second organization to which the second administrator belongs. In the embodiment, the first terminal device 400 may be used as the second management device.

The setting management unit 333 stores, in the storage unit 310, the setting that is set in this way and is related to the use of the image forming device 600 by the external user. The above-described external user information request setting process performed by the first administrator and the above-described external printer usage information provision setting process performed by the second administrator will be described in detail using a sequence chart to be described below.

The device identification information acquisition unit 334 acquires identification information on the image forming device 600 that is included in the code image C attached to the image forming device 600. More specifically, the device identification information acquisition unit 334 acquires, from the second terminal device 500, the identification information on the image forming device 600, which is included in the code image C read by the second terminal device 500.

The printing control unit 335 performs a control process for executing printing performed by the image forming device 600 that is a printer registered in the second printing service system 200. In other words, the printing control unit 335 performs a control process for executing printing performed by the image forming device 600 associated with the virtual printer registered in the first printing service system 100. At this time, the printing control unit 335 associates the code virtual printer with the image forming device 600 based on the identification information on the image forming device 600 included in the code image C. The printing control unit 335 performs a process of acquiring information required for performing printing from the first printing service system 100, a process of transmitting a printing request to the second printing service system 200 based on the information, a process of notifying the first printing service system 100 of a job state, and the like.

In particular, in the embodiment, the printing control unit 335 performs the following process.

The printing control unit 335 acquires user information from the first printing service system 100 based on the authentication completion information acquired by the authentication control unit 331, acquires printing job information corresponding to the user information from the first printing service system 100, and transmits, to the second printing service system 200, a request to cause the image forming device 600 to execute printing for the acquired printing job information. Therefore, when the authentication completion information cannot be acquired, the printing control unit 335 does not acquire the printing job for the user from the first printing service system 100. Therefore, printing is not executed in such a case. As described above, in the embodiment, authentication printing using authentication performed by the first printing service system 100 is implemented in printing performed by the image forming device 600 connected to the second printing service system 200. Therefore, unauthorized use of the system can be prevented.

When the device identification information acquisition unit 334 acquires the identification information on the image forming device 600 included in the code image C, the printing control unit 335 acquires, from the first printing service system 100, a printing job for which the use of the code virtual printer registered in the first printing service system 100 is designated. More specifically, the printing control unit 335 acquires a printing job corresponding to the user who performs the printing operation among such printing jobs. Then, the printing control unit 335 transmits, to the second printing service system 200, a request to cause the image forming device 600 identified by the identification information acquired by the device identification information acquisition unit 334 to execute printing for the printing job. Therefore, in the embodiment, even in the printing system in which different systems providing printing services cooperate with each other, the user can designate, by using the code image C attached to the image forming device 600, the image forming device 600 to be used for printing.

The printing control unit 335 refers to a rule that is related to the use of the image forming device 600 identified by the identification information acquired by the device identification information acquisition unit 334 and is applied to a user who performs a printing operation (a user corresponding to a printing job to be processed). Specifically, the printing control unit 335 refers to the setting information stored in the storage unit 310. Then, the printing control unit 335 executes a process of controlling the use of the image forming device 600 identified by the identification information by the user according to the referred rule. Accordingly, even when various users use the printing system 10, the use of the image forming device 600 can be controlled according to a rule corresponding to each user.

The process of controlling the use by the user includes a process of prohibiting the use of the image forming device 600 identified by the identification information acquired by the device identification information acquisition unit 334. In this case, the printing control unit 335 may transmit, to the second terminal device 500, a notification indicating that the use of the image forming device 600 is prohibited. The process of controlling the use by the user includes a process of transmitting, to the second terminal device 500, a notification of warning the use of the image forming device 600 identified by the identification information acquired by the device identification information acquisition unit 334. The printing control unit 335 executes the processes according to the setting information stored in the storage unit 310, that is, the rule generated by the setting management unit 333.

In the embodiment, the image forming device 600 can also be used by an external user who is a user out of the organization for managing the image forming device 600. Specifically, the printing control unit 335 can determine whether the external user can use the image forming device 600 based on the setting that is set by the setting management unit 333 and is related to the use of the image forming device 600 by the external user. That is, the printing control unit 335 can determine whether the external user can use the image forming device 600 based on the type of the external user information set by the first administrator and requested when the external user uses the image forming device 600, and the information set by the second administrator and can be provided when the external user uses the external image forming device 600.

For example, when the external user provides information set by the first administrator and to be provided by the external user, the printing control unit 335 may permit printing using the image forming device 600. On the other hand, when the external user does not provide information set by the first administrator and to be provided by the external user, the printing control unit 335 may not permit printing using the image forming device 600. In this case, a message indicating that printing is not permitted may be transmitted to the second terminal device 500 of the external user. When the information to be provided by the external user is included in information that can be provided by the external user, the printing control unit 335 may transmit, to the second terminal device 500 of the external user, a screen for inquiring whether to provide the information that can be provided by the external user. When the external user uses the second terminal device 500 to transmit information indicating the provision of the information to be provided by the external user to the relay server 300, printing using the image forming device 600 may be permitted.

For example, when the external user provides the information to be provided by the external user, the printing control unit 335 may not request the external user to provide the information to be provided by the external user in subsequent printing. For example, in a case in which the external user provides the information to be provided by the external user when a specific image forming device 600_1 is used, the printing control unit 335 may not request the external user to provide the information to be provided by the external user when the specific image forming device 600_1 is used thereafter. For example, in a case in which the external user provides the information to be provided by the external user when the image forming device 600 belonging to a specific organization is used, the printing control unit 335 may not request the external user to provide the information to be provided by the external user when the image forming device 600 belonging to the specific organization is used thereafter.

In a case in which the external user does not provide the information to be provided by the external user when the specific image forming device 600 is used, the printing control unit 335 may prevent the external user from using the specific image forming device 600 thereafter. For example, in a case in which the external user does not provide the information to be provided by the external user when the image forming device 600 belonging to the specific organization is used, the printing control unit 335 may prevent the image forming device 600 belonging to the specific organization from being used thereafter.

The printing control unit 335 acquires the job state information corresponding to the printing job information from the second printing service system 200. When the job state information is acquired, the printing control unit 335 stores the printing history information corresponding to the job state information in the storage unit 310. The job state information includes information such as a virtual printer ID, a job ID2, a job state, and the number of pages to be printed. The printing history information includes information such as a printing completion time point, a printer ID, the number of printed pages, and external user information.

The processes performed by the printing control unit 335 are described above, and a specific process performed by the printing control unit 335 in the embodiment will be described using a sequence chart to be described later.

The printing history information acquisition unit 336 acquires the printing history information on the image forming device 600 from the storage unit 310. For example, the printing history information acquisition unit 336 acquires the printing history information on the image forming device 600 from the storage unit 310 in response to a request from an administrator who manages the image forming device 600. For example, when receiving a printing history information request to request printing history information from the first terminal device 400, an organization identification information acquisition unit 338 may acquire organization identification information from the first printing service system 100 based on the printing history information request. When receiving a printing history information request to request printing history information from the first terminal device 400, the relay server 300 may transmit the printing history information to the first terminal device 400. Here, the first terminal device 400 corresponds to the first management device that is a management device for the first organization. That is, the first administrator of the first organization can acquire the printing history information from the relay server 300 by operating the first terminal device 400. The printing history information includes printing history information on the external user, and therefore, the first administrator of the first organization can charge the second administrator of the second organization, which is an organization for the external user, for the cost of using the image forming device 600.

In the embodiment, the printing system 10 may include a cost settlement device. In this case, when receiving a printing history information request to request the printing history information from the cost settlement device, the relay server 300 may transmit the printing history information to the cost settlement device. Accordingly, the cost settlement device can calculate a cost of using the image forming device 600 and charge the second administrator of the second organization, which is the organization of the external user, for the cost of using the image forming device 600. The cost of using the image forming device 600 can be calculated by the relay server 300, or may be calculated by the first terminal device 400 or the cost settlement device. Accordingly, even when the external user uses the printing system, the external user can be easily charged for the printing cost.

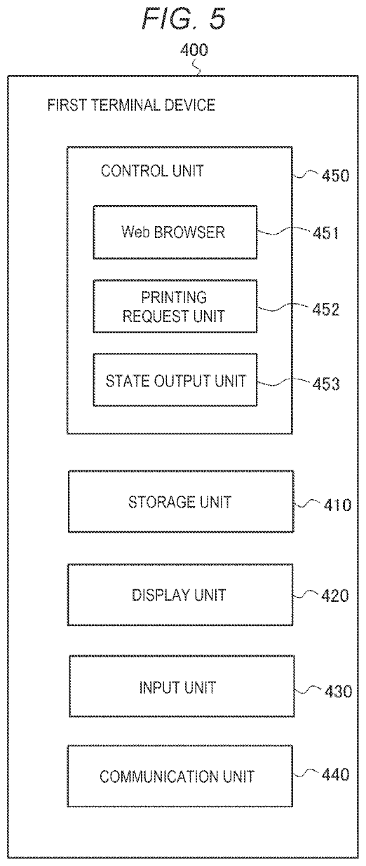

Next, a configuration of the first terminal device 400 will be described. FIG. 5 is a block diagram showing an example of the configuration of the first terminal device 400. As shown in FIG. 5, the first terminal device 400 includes a storage unit 410, a display unit 420, an input unit 430, a communication unit 440, and a control unit 450.

The storage unit 410 is a storage device that stores a program for implementing a process performed by the control unit 450 and data used for a process performed by the first terminal device 400. The storage device may be a nonvolatile storage device such as a hard disk or a flash memory, and may include a memory such as a RAM. The display unit 420 is a device for displaying information, and is, for example, a display such as a flat panel display. The input unit 430 is a device that receives an input operation from a user, and is, for example, a keyboard or a mouse. The display unit 420 and the input unit 430 may be integrally implemented by a touch panel or the like. The communication unit 440 is a communication interface for communicating with other devices such as the first printing service system 100 and the relay server 300 via a wireless network or a wired network. The control unit 450 is a processor, such as a CPU, that controls components of the first terminal device 400. The control unit 450 may include a plurality of processors. The control unit 450 reads a program into the memory and executes the program. Accordingly, the control unit 450 implements functions of a Web browser 451, a printing request unit 452, and a state output unit 453.

The Web browser 451 is a known Web browser, and in the embodiment, performs a process of displaying a Web page provided from the first printing service system 100 or the relay server 300 on the display unit 420, a process of transmitting input information for the Web page, and the like. The Web browser 451 may transmit a printing history information request for requesting printing history information to the relay server 300. A specific process performed by the Web browser 451 in the embodiment will be described with reference to a sequence chart to be described later.

The printing request unit 452 performs a process of requesting printing in response to an operation from the user. In the embodiment, in particular, the printing request unit 452 requests the first printing service system 100 to perform printing. A specific process performed by the printing request unit 452 in the embodiment will be described with reference to a sequence chart to be described later.

The state output unit 453 performs a process of acquiring a job state to be described later via the first printing service system 100 and outputting the job state. In the embodiment, the state output unit 453 outputs the job state to the display unit 420, but does not necessarily have to output by display. For example, the state output unit 453 may output the job state by voice or the like. The state output unit 453 may be provided in the first terminal device 400 as a function of the Web browser 451. A specific process performed by the state output unit 453 in the embodiment will be described using a sequence chart to be described later.

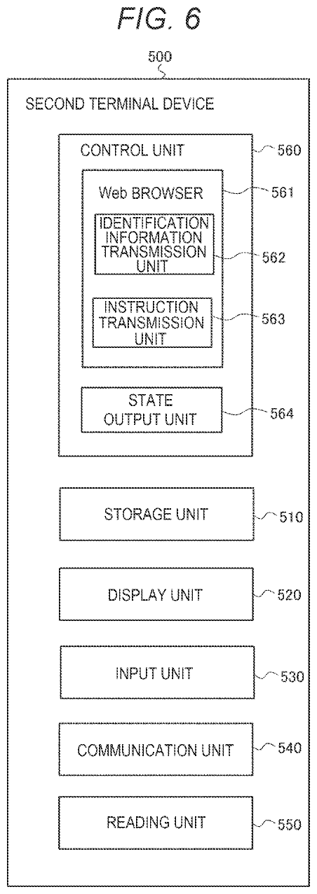

FIG. 6 is a block diagram showing an example of a configuration of the second terminal device 500. As shown in FIG. 6, the second terminal device 500 includes a storage unit 510, a display unit 520, an input unit 530, a communication unit 540, a reading unit 550, and a control unit 560.

The storage unit 510 is a storage device that stores a program for implementing a process performed by the control unit 560 and data used for a process performed by the second terminal device 500. The storage device may be a nonvolatile storage device such as a hard disk or a flash memory, and may include a memory such as a RAM. The display unit 520 is a device for displaying information, and is, for example, a display such as a flat panel display. The input unit 530 is a device that receives an input operation from a user, and is, for example, a keyboard or a mouse. As described above, since the second terminal device 500 is preferably a mobile terminal, the display unit 520 and the input unit 530 are preferably integrally implemented by a touch panel or the like. The communication unit 540 is a communication interface for communicating with other devices such as the first printing service system 100 and the relay server 300 via a wireless network or a wired network. The reading unit 550 is a device reading the code image C attached to the image forming device 600, and is specifically, for example, a camera. The control unit 560 is a processor, such as a CPU, that controls components of the second terminal device 500. The control unit 560 may include a plurality of processors. The control unit 560 reads a program into the memory and executes the program. Accordingly, the control unit 560 implements functions of a Web browser 561, an identification information transmission unit 562, an instruction transmission unit 563, and a state output unit 564.

The Web browser 561 is a known Web browser, and in the embodiment, performs a process of displaying a Web page provided from the first printing service system 100 or the relay server 300 on the display unit 520, a process of transmitting input information for the Web page, and the like. In particular, in the embodiment, the Web browser 561 functions as the identification information transmission unit 562. The identification information transmission unit 562 transmits, to the relay server 300, the identification information on the image forming device 600 that is included in the code image C read by the reading unit 550. In the embodiment, the Web browser 561 functions as the instruction transmission unit 563. The instruction transmission unit 563 transmits, to the relay server 300, an instruction from the user input via the input unit 530. In particular, the instruction transmission unit 563 transmits an instruction to select whether to use the image forming device 600 warned by the relay server 300, an instruction related to application of the above-described rule, an instruction to execute printing, a printing cancellation instruction, and the like. A specific process performed by the Web browser 561 in the embodiment will be described with reference to a sequence chart to be described later.

The state output unit 564 performs a process of acquiring a job state to be described later via the first printing service system 100 and outputting the job state. In the embodiment, the state output unit 564 outputs the job state to the display unit 520, but does not necessarily have to output by display. For example, the state output unit 564 may output the job state by voice or the like. A specific process performed by the state output unit 564 in the embodiment will be described with reference to a sequence chart to be described later.

In the configuration shown in FIG. 6, the identification information transmission unit 562 and the instruction transmission unit 563 have been described as the function of the Web browser 561, and the identification information transmission unit 562 and the instruction transmission unit 563 are not necessarily provided as the function of the Web browser 561. That is, the identification information transmission unit 562 and the instruction transmission unit 563 may be present in the second terminal device 500 as a function independent of the Web browser 561. The state output unit 564 may be provided in the second terminal device 500 as a function of the Web browser 561. The control unit 560 of the second terminal device 500 may have the same function as the printing request unit 452 of the first terminal device 400.

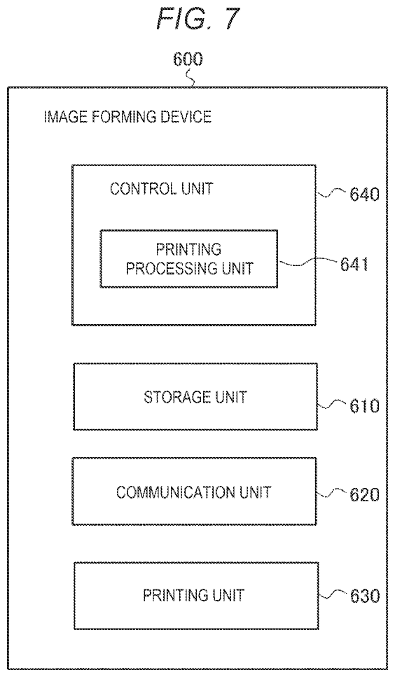

FIG. 7 is a block diagram showing an example of a configuration of the image forming device 600. As shown in FIG. 7, the image forming device 600 includes a storage unit 610, a communication unit 620, a printing unit 630, and a control unit 640.

The storage unit 610 is a storage device that stores a program for implementing a process performed by the control unit 640 and data used for a process performed by the image forming device 600. The storage device may be a nonvolatile storage device such as a hard disk or a flash memory, and may include a memory such as a RAM. The communication unit 620 is a communication interface for performing communication with other devices such as the second printing service system 200 via a wireless network or a wired network. The control unit 640 is a processor, such as a CPU, that controls components of the image forming device 600. The control unit 640 may include a plurality of processors. The control unit 640 reads a program into the memory and executes the program. Accordingly, the control unit 640 implements a function of a printing processing unit 641.

The printing processing unit 641 performs a process for executing printing by the printing unit 630. The printing processing unit 641 notifies the second printing service system 200 of a job state of a printing job. A specific process performed by the printing processing unit 641 in the embodiment will be described using a sequence chart to be described later.

The printing unit 630 has a printing function for forming an image on a printing medium such as a sheet. The printing unit 630 includes a printing engine. The printing engine is a mechanical configuration that prints an image on the printing medium using a color material. The printing engine may include a mechanism for printing using ink by, for example, an inkjet method. Alternatively, the printing engine may include a mechanism for printing using toner by, for example, electrophotography. The printing engine may include a conveyance mechanism that conveys the printing medium.

The image forming device 600 may further include a user interface such as a touch panel display. In the embodiment, as described above, the image forming device 600 includes the printing unit 630 and has a function of a printer. Therefore, the image forming device 600 is also referred to as a printer.

Next, a flow of a process performed by the printing system 10 will be described using a sequence chart.

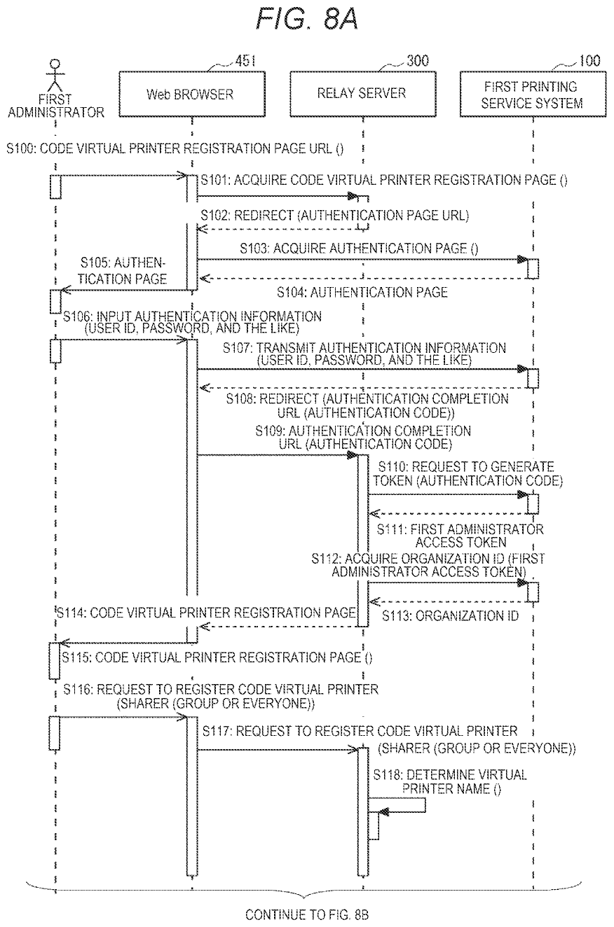

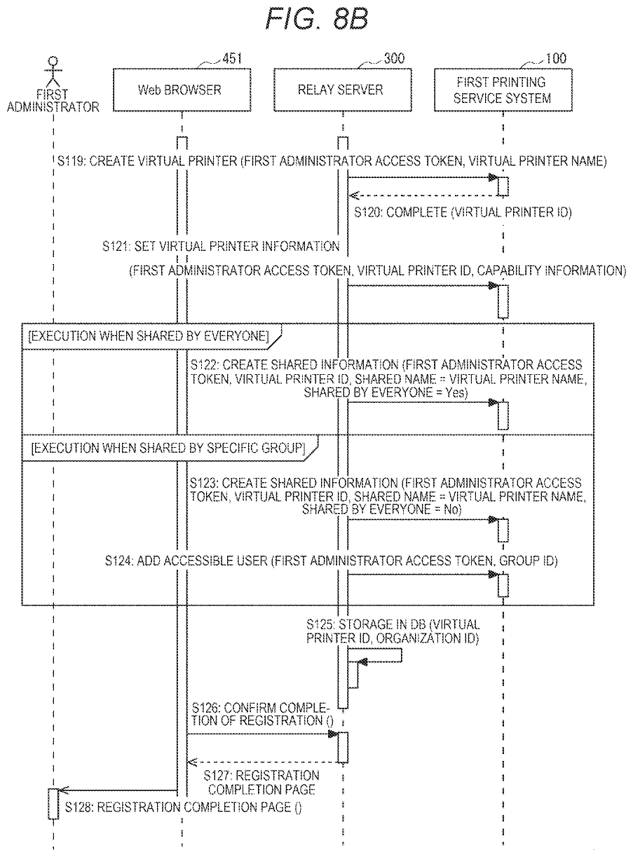

First, a flow of a process for registering a code virtual printer in the first printing service system 100 in order to enable designation of an output destination by reading the code image C will be described. That is, a flow of a process for registering, in the first printing service system 100, a dedicated virtual printer for a printing job in which an output destination is designated by reading the code image C will be described. FIGS. 8A and 8B are sequence charts showing an example of the flow of a code virtual printer registering process executed by the printing system 10. An order of processes of steps in the sequence chart is merely an example, and can be appropriately changed as long as there is no technical contradiction. The flow of the code virtual printer registering process is described below with reference to FIGS. 8A and 8B.

In step S100, the first administrator of the first organization who manages the image forming device 600 performs, via the input unit 430 of the first terminal device 400, a predetermined operation for starting the code virtual printer registering process. Accordingly, for example, a URL of a code virtual printer registration page is input to the Web browser 451 of the first terminal device 400. Here, the code virtual printer registration page is a page prepared to register the code virtual printer in the first printing service system 100. After step S100, in step S101, the Web browser 451 transmits, according to the input URL, a request to acquire the code virtual printer registration page to the relay server 300. In response to this, in step S102, the authentication control unit 331 of the relay server 300 instructs the Web browser 451 to access a predetermined redirect page. In this step, the predetermined redirect page is an authentication page. Therefore, the authentication control unit 331 of the relay server 300 transmits a URL of the authentication page to the Web browser 451. The authentication page is a page for requesting the user to input authentication information.

In step S103, the Web browser 451 transmits, according to the received URL, a request to acquire the authentication page to the first printing service system 100. In response to this, in step S104, the authentication control unit 131 of the first printing service system 100 transmits the authentication page to the Web browser 451. Accordingly, in step S105, the Web browser 451 displays the authentication page on the display unit 420 of the first terminal device 400.

In step S106, the first administrator inputs the authentication information to the authentication page via the input unit 430. Specifically, for example, the first administrator inputs a user ID, a password, and the like of the first administrator. Here, the required authentication information is authentication information used in the first printing service system 100, and specifically, is a user ID, a password, and the like registered in advance. In step S107, the Web browser 451 transmits the input authentication information to the first printing service system 100. The authentication control unit 131 of the first printing service system 100 performs an authentication process based on the authentication information received from the Web browser 451. That is, the authentication control unit 131 determines whether the received authentication information matches authentication information on the first administrator that is registered in advance.

When the authentication is successful in the authentication process, that is, when the received authentication information matches the authentication information on the first administrator that is registered in advance, in step S108, the authentication control unit 131 of the first printing service system 100 issues an authentication code and further instructs the Web browser 451 to access a predetermined redirect destination. The predetermined redirect destination is the relay server 300. By this redirect, the authentication code is passed to the relay server 300. Therefore, the authentication control unit 131 of the first printing service system 100 transmits a URL indicating the predetermined redirect destination to the Web browser 451, together with the authentication code.

In step S109, the Web browser 451 accesses the predetermined redirect destination together with the authentication code. Accordingly, the relay server 300 acquires the authentication code. Then, in step S110, the authentication control unit 331 of the relay server 300 transmits a request to request generation of a first administrator access token to the first printing service system 100, together with the received authentication code. The first administrator access token is information certifying that the access is a valid access of the first administrator, that is, an access with a valid authority as the first administrator. In step S111, after confirming that the authentication code received in step S110 matches the authentication code transmitted in step S108, the authentication control unit 131 of the first printing service system 100 issues a first administrator access token and transmits the first administrator access token to the relay server 300. In step S112, the authentication control unit 331 of the relay server 300 transmits a request for acquiring an organization ID of the first administrator to the first printing service system 100, together with the first administrator access token. In step S113, the authentication control unit 131 of the first printing service system 100 transmits information on the organization ID corresponding to the first administrator access token to the relay server 300.

Thereafter, in step S114, the registration unit 332 transmits the code virtual printer registration page to the Web browser 451. Accordingly, in step S115, the Web browser 451 displays the code virtual printer registration page on the display unit 420 of the first terminal device 400. In step S116, the first administrator performs, via the input unit 430 of the first terminal device 400, a predetermined operation of requesting registration of the code virtual printer. More specifically, in step S116, the first administrator inputs information that designates a sharer to the code virtual printer registration page displayed in step S115. The sharer is a user who can use the code virtual printer. The information that designates the sharer may be information that designates a user belonging to a specific group as the sharer. In this case, the information that designates the sharer may be identification information for specifying a group, such as a group ID. Instead of the identification information that specifies the group, a user ID of each of a plurality of users designated as the sharers may be input. The information that designates the sharer may be information that specifies any user, that is, all users, as the sharer.

Next, in step S117, the Web browser 451 transmits, to the relay server 300, a request to request registration of the code virtual printer in the first printing service system 100, together with the information that designates the sharer. Accordingly, the registration unit 332 of the relay server 300 acquires a code virtual printer registration instruction from the first administrator.

Next, in step S118, the registration unit 332 of the relay server 300 determines a printer name of the code virtual printer to be registered in the first printing service system 100. The registration unit 332 determines, for example, a predetermined printer name with which the user can identify the code virtual printer as the printer name of the code virtual printer to be registered in the first printing service system 100.

Next, in step S119, the registration unit 332 of the relay server 300 requests the first printing service system 100 to register the code virtual printer using the first administrator access token acquired in step S111. Specifically, in step S119, the registration unit 332 transmits a request to create and register the code virtual printer to the first printing service system 100, together with the first administrator access token. At this time, the registration unit 332 transmits the virtual printer name determined in step S118 together with the request. That is, the registration unit 332 requests the registration of the virtual printer and the setting of the virtual printer name.

In response to this, in step S120, when the authentication control unit 131 confirms that the first administrator access token received in step S119 is valid, the information management unit 133 of the first printing service system 100 registers a new virtual printer in the first printing service system 100. At this time, the information management unit 133 sets the virtual printer name received in step S119 as a printer name of a virtual printer to be newly registered. The information management unit 133 determines a virtual printer ID for the new virtual printer as identification information of the new virtual printer, and notifies the relay server 300 of completion of the registration of the virtual printer together with the virtual printer ID.

Thereafter, in steps S121 to S124, a setting process for the newly registered virtual printer is performed. Specifically, in step S121, the registration unit 332 of the relay server 300 transmits a request to set capability information on the newly registered virtual printer to the first printing service system 100, together with the first administrator access token. At this time, the registration unit 332 transmits the virtual printer ID notified in step S120 and the capability information together with the request. The capability information is information indicating the capability of the image forming device 600 associated with the code virtual printer as a printer, and can also be said to be information that specifies a function of the image forming device 600 as a printer. The capability information may be, for example, information indicating whether double-sided printing is possible or information indicating whether color printing is possible. As described above, any image forming device 600 may be associated with the code virtual printer. Therefore, the registration unit 332 may transmit, as the capability information, only a function common to all the image forming devices 600 that may be associated with the code virtual printer, or may transmit, as the capability information, information indicating that the capability is unknown. In response to this, when the authentication control unit 131 confirms that the first administrator access token received in step S121 is valid, the information management unit 133 of the first printing service system 100 performs a setting of the virtual printer specified by the received virtual printer ID. Specifically, the information management unit 133 uses the received capability information as the capability information on the code virtual printer specified by the received virtual printer ID. Accordingly, the created capability information of the code virtual printer is set.

In step S122, step S123, and step S124, the registration unit 332 of the relay server 300 performs a setting related to the shared use of the newly registered virtual printer. That is, in step S122, step S123, and step S124, the setting of the access right for the code virtual printer is performed. Here, the following specific processes are performed in order to perform the setting of the code virtual printer to be used as a shared printer. The shared printer is a printer that is assumed to be used by a plurality of users. That is, the shared printer is a printer shared by a plurality of users. When the shared printer, which is a code virtual printer, is shared by any user, that is, when the relay server 300 receives information that designates any user as a sharer in step S117, the registration unit 332 executes a process in step S122 to be described below. When the shared printer, which is a code virtual printer, is shared by a user belonging to a specific group, that is, when the relay server 300 receives information that designates a user belonging to a specific group as a sharer in step S117, the registration unit 332 executes processes in step S123 and step S124 to be described below.

When the relay server 300 receives information that designates any user as a sharer, the registration unit 332 performs a process for creating shared information in step S122. As described above, since it is necessary to allow any user to use the code virtual printer, shared information that permits sharing by any user is created. More specifically, in step S122, the registration unit 332 transmits a request to set the shared information on the newly registered code virtual printer to the first printing service system 100, together with the first administrator access token. At this time, together with the request, the registration unit 332 transmits the virtual printer ID notified in step S120 and an instruction to designate that sharing by any user is permitted. In the description of step S122 in the sequence chart, a description in which “Yes” is set to a value of a flag indicating sharing by everyone (“sharing by everyone=Yes”) represents an instruction to designate that sharing by any user is permitted. At this time, the registration unit 332 may transmit a shared name for identifying newly created shared information to the first printing service system 100. For example, the virtual printer name determined in step S116 may be used as such a shared name. The transmission of the shared name may be omitted. In response to this, when the authentication control unit 131 confirms that the first administrator access token received in step S122 is valid, the information management unit 133 of the first printing service system 100 creates, based on the received information, shared information on the virtual printer specified by the virtual printer ID. Specifically, the information management unit 133 creates shared information indicating that the sharing by any user is permitted.

When the relay server 300 receives the information that designates a user belonging to a specific group as a sharer, the registration unit 332 first performs a process for creating shared information in step S123. Since it is necessary to prevent a user other than the user belonging to the specific group from using the code virtual printer, shared information not permitting sharing by any user is created. More specifically, in step S123, the registration unit 332 transmits a request to set shared information on the newly registered virtual printer to the first printing service system 100, together with the first administrator access token. At this time, together with the request, the registration unit 332 also transmits the virtual printer ID notified in step S120 and an instruction to designate that sharing by any user is not permitted. In the description of step S123 in the sequence chart, a description in which “No” is set to a value of a flag indicating sharing by everyone (“sharing by everyone=No”) indicates an instruction to designate that sharing by any user is not permitted. At this time, the registration unit 332 may transmit a shared name for identifying newly created shared information to the first printing service system 100. For example, the virtual printer name determined in step S118 may be used as such a shared name. The transmission of the shared name may be omitted. In response to this, when the authentication control unit 131 confirms that the first administrator access token received in step S123 is valid, the information management unit 133 of the first printing service system 100 creates, based on the received information, shared information on the virtual printer specified by the virtual printer ID. Specifically, the information management unit 133 creates shared information indicating that sharing by any user is not permitted.

In step S124, the registration unit 332 performs a process of correcting the shared information such that only the user belonging to the specific group can use a printer to be registered. Specifically, in step S124, the registration unit 332 transmits, to the first printing service system 100, a request to correct the shared information so as to permit the user belonging to the specific group to use the virtual printer, together with the first administrator access token. At this time, the registration unit 332 transmits, for example, the group ID acquired in step S117 as information for specifying a user to whom sharing is permitted. In response to this, when the authentication control unit 131 confirms that the first administrator access token received in step S124 is valid, the information management unit 133 of the first printing service system 100 updates the shared information based on the received information. Specifically, the information management unit 133 updates the shared information so as to permit the use of the user specified by the received group ID. In the sequence chart shown in FIG. 8B, the setting of the shared information is performed through the two steps, step S123 and step S124, and these processes may be performed in one step. In the embodiment, it is assumed that the user to whom sharing is permitted includes an external user. For example, the group ID acquired in step S117 includes an ID of a group including an external user. For example, the group ID may include an organization ID of an external user.

After step S122 or step S124, in step S125, the registration unit 332 of the relay server 300 stores, in a database of the storage unit 310 or the like, the virtual printer ID of the virtual printer registered as the code virtual printer and the organization ID of the organization to which the virtual printer ID belongs. In the embodiment, the organization ID to which the virtual printer ID belongs is the same as the organization ID of the first administrator.

In step S126, the Web browser 451 inquires of the relay server 300 whether the code virtual printer registering process is completed. In response to this, in step S127, the registration unit 332 of the relay server 300 transmits a registration completion page, which is a page indicating that the registration is completed, to the Web browser 451. Accordingly, in step S128, the Web browser 451 displays the registration completion page on the display unit 420 of the first terminal device 400. In the sequence chart shown here, the step of inquiring whether the code virtual printer registering process is completed is performed after step S125, and may be performed periodically before step S125. In this case, the registration unit 332 may transmit a page indicating that the registration is not completed to the Web browser 451.

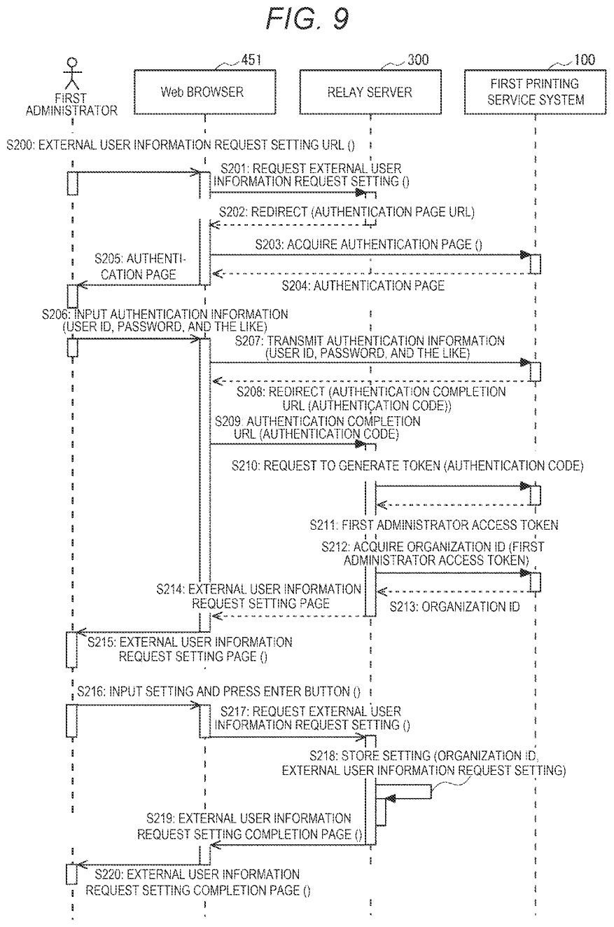

Next, a flow of an external user information request setting process will be described using a sequence chart shown in FIG. 9. Here, the external user information request setting is a process of setting information requested from the external user when the external user uses the image forming device 600. That is, the first administrator of the first organization who owns the image forming device 600 sets information to be provided by the external user when the external user uses the image forming device 600.

As shown in FIG. 9, first, in step S200, the first administrator of the first organization who manages the image forming device 600 performs, via the input unit 430 of the first terminal device 400, a predetermined operation for starting the external user information request setting process. Accordingly, for example, a URL of an external user information request setting page is input to the Web browser 451 of the first terminal device 400. Here, the external user information request setting page is a page prepared to register the external user information request setting in the relay server 300. After step S200, in step S201, the Web browser 451 transmits, according to the input URL, a request to acquire the external user information request setting page to the relay server 300. In response to this, in step S202, the authentication control unit 331 of the relay server 300 instructs the Web browser 451 to access a predetermined redirect page. In this step, the predetermined redirect page is an authentication page. Therefore, the authentication control unit 331 of the relay server 300 transmits a URL of the authentication page to the Web browser 451. The authentication page is a page for requesting the user to input authentication information.

In step S203, the Web browser 451 transmits, according to the received URL, a request to acquire the authentication page to the first printing service system 100. In response to this, in step S204, the authentication control unit 131 of the first printing service system 100 transmits the authentication page to the Web browser 451. Accordingly, in step S205, the Web browser 451 displays the authentication page on the display unit 420 of the first terminal device 400.

In step S206, the first administrator inputs the authentication information to the authentication page via the input unit 430. Specifically, for example, the first administrator inputs a user ID, a password, and the like of the first administrator. Here, the required authentication information is authentication information used in the first printing service system 100, and specifically, is a user ID, a password, and the like registered in advance. In step S207, the Web browser 451 transmits the input authentication information to the first printing service system 100. The authentication control unit 131 of the first printing service system 100 performs an authentication process based on the authentication information received from the Web browser 451. That is, the authentication control unit 131 determines whether the received authentication information matches authentication information on the first administrator that is registered in advance.

When the authentication is successful in the authentication process, that is, when the received authentication information matches the authentication information on the first administrator registered in advance, in step S208, the authentication control unit 131 of the first printing service system 100 issues an authentication code and further instructs the Web browser 451 to access a predetermined redirect destination. The predetermined redirect destination is the relay server 300. By this redirect, the authentication code is passed to the relay server 300. Therefore, the authentication control unit 131 of the first printing service system 100 transmits a URL indicating the predetermined redirect destination to the Web browser 451, together with the authentication code.

In step S209, the Web browser 451 accesses a predetermined redirect destination together with the authentication code. Accordingly, the relay server 300 acquires the authentication code. Then, in step S210, the authentication control unit 331 of the relay server 300 transmits a request to request generation of a first administrator access token to the first printing service system 100, together with the received authentication code. The first administrator access token is information certifying that the access is a valid access of the first administrator, that is, an access with a valid authority as the first administrator. In step S211, after confirming that the authentication code received in step S210 matches the authentication code transmitted in step S208, the authentication control unit 131 of the first printing service system 100 issues a first administrator access token and transmits the first administrator access token to the relay server 300. In step S212, the authentication control unit 331 of the relay server 300 transmits a request for acquiring an organization ID of the first administrator to the first printing service system 100, together with the first administrator access token. In step S213, the authentication control unit 131 of the first printing service system 100 transmits information on the organization ID corresponding to the first administrator access token to the relay server 300.

Thereafter, in step S214, the registration unit 332 transmits the external user information request setting page to the Web browser 451. Accordingly, in step S215, the Web browser 451 displays the external user information request setting page on the display unit 420 of the first terminal device 400.

The external user information request setting page is a page for setting information to be requested from the external user when the external user uses the image forming device 600, and in step S216, the first administrator performs an input in the external user information request setting page via the input unit 430 to set the external user information request, and presses an enter button displayed on the external user information request setting page.

Specifically, the first administrator sets what kind of information to request as the external user information when the external user uses the image forming device 600. Here, the external user information is information used for an administrator of the first organization to which the image forming device 600 belongs to charge the external user for a cost when the external user uses the image forming device 600. The external user information is information by which an external user can be uniquely identified, and includes, for example, a user ID and an email address. As the external user information, information obtained by combining a unique value (such as UUID) and an organization ID in the organization to which the external user belongs may be used. The external user information may be information by which the organization to which the external user belongs can be uniquely identified, and an organization ID, a domain name, or the like can be used in this case.

In step S217, the Web browser 451 transmits the input external user information request setting to the relay server 300, and requests the relay server 300 to perform the external user information request setting. In response to this, in step S218, the setting management unit 333 of the relay server 300 stores the external user information request setting in the storage unit 310 in association with the organization ID acquired in step S213.

Thereafter, in step S219, the setting management unit 333 transmits an external user information request setting completion page to the Web browser 451. The external user information request setting completion page is a page for notifying that the external user information request setting is appropriately stored in the relay server 300. Accordingly, in step S220, the Web browser 451 displays the external user information request setting completion page on the display unit 420 of the first terminal device 400.

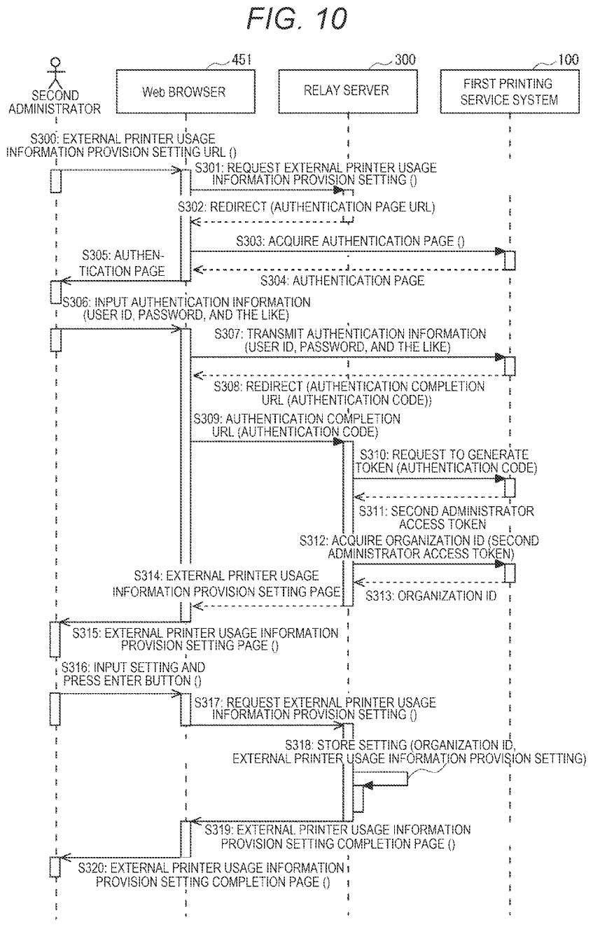

Next, a flow of an external printer usage information provision setting process is described using a sequence chart shown in FIG. 10. The second administrator of the second organization to which the external user belongs sets information that can be provided when the external user uses the external image forming device 600. That is, the second administrator sets whether to provide personal information used for authentication of the external user. FIG. 10 shows a case in which the second administrator uses the Web browser 451 of the first terminal device 400 to execute the external printer usage information provision setting process, and in the embodiment, the second administrator may execute such a process using other terminal devices.

As shown in FIG. 10, first, in step S300, the second administrator of the second organization to which the external user belongs performs, via the input unit 430 of the first terminal device 400, a predetermined operation for starting the external printer usage information provision setting process. Accordingly, for example, a URL of an external printer usage information provision setting page is input to the Web browser 451 of the first terminal device 400. The external printer usage information provision setting page is a page prepared to register the external printer usage information provision setting in the relay server 300.

After step S300, in step S301, the Web browser 451 transmits, according to the input URL, a request to acquire the external printer usage information provision setting page to the relay server 300. In response to this, in step S302, the authentication control unit 331 of the relay server 300 instructs the Web browser 451 to access a predetermined redirect page. In this step, the predetermined redirect page is an authentication page. Therefore, the authentication control unit 331 of the relay server 300 transmits a URL of the authentication page to the Web browser 451. The authentication page is a page for requesting the user to input authentication information.

In step S303, the Web browser 451 transmits, according to the received URL, a request to acquire the authentication page to the first printing service system 100. In response to this, in step S304, the authentication control unit 131 of the first printing service system 100 transmits the authentication page to the Web browser 451. Accordingly, in step S305, the Web browser 451 displays the authentication page on the display unit 420 of the first terminal device 400.

In step S306, the second administrator inputs the authentication information to the authentication page via the input unit 430. Specifically, for example, the second administrator inputs a user ID, a password, and the like of the second administrator. Here, the required authentication information is authentication information used in the first printing service system 100, and specifically, is a user ID, a password, and the like registered in advance. In step S307, the Web browser 451 transmits the input authentication information to the first printing service system 100. The authentication control unit 131 of the first printing service system 100 performs an authentication process based on the authentication information received from the Web browser 451. That is, the authentication control unit 131 determines whether the received authentication information matches the authentication information on the second administrator registered in advance.

When the authentication is successful in the authentication process, that is, when the received authentication information matches the authentication information on the second administrator registered in advance, in step S308, the authentication control unit 131 of the first printing service system 100 issues an authentication code and instructs the Web browser 451 to access a predetermined redirect destination. The predetermined redirect destination is the relay server 300. By this redirect, the authentication code is passed to the relay server 300. Therefore, the authentication control unit 131 of the first printing service system 100 transmits a URL indicating the predetermined redirect destination to the Web browser 451, together with the authentication code.

In step S309, the Web browser 451 accesses the predetermined redirect destination together with the authentication code. Accordingly, the relay server 300 acquires the authentication code. Then, in step S310, the authentication control unit 331 of the relay server 300 transmits a request to request generation of a second administrator access token to the first printing service system 100, together with the received authentication code. The second administrator access token is information certifying that the access is a valid access of the second administrator, that is, an access with a valid authority as the second administrator. In step S311, after confirming that the authentication code received in step S310 matches the authentication code transmitted in step S308, the authentication control unit 131 of the first printing service system 100 issues a second-administrator access token and transmits the second-administrator access token to the relay server 300. In step S312, the authentication control unit 331 of the relay server 300 transmits a request for acquiring an organization ID of the second administrator to the first printing service system 100, together with the second administrator access token. In step S313, the authentication control unit 131 of the first printing service system 100 transmits information on the organization ID corresponding to the second administrator access token to the relay server 300.

Thereafter, in step S314, the registration unit 332 transmits the external printer usage information provision setting page to the Web browser 451. Accordingly, in step S315, the Web browser 451 displays the external printer usage information provision setting page on the display unit 420 of the first terminal device 400.

The external printer usage information provision setting page is a page for setting information that can be provided when the external user uses the image forming device 600. In step S316, the second administrator performs an input in the external printer usage information provision setting page via the input unit 430 to set information that can be provided by the external user, and presses an enter button displayed on the external printer usage information provision setting page. For example, the second administrator may set availability of provision for each type of the above-described external user information.

In step S317, the Web browser 451 transmits the input external printer usage information provision setting to the relay server 300, and requests the relay server 300 to perform the external printer usage information provision setting. In response to this, in step S318, the setting management unit 333 of the relay server 300 stores the external printer usage information provision setting in the storage unit 310 in association with the organization ID acquired in step S313.

Thereafter, in step S319, the setting management unit 333 transmits an external printer usage information provision setting completion page to the Web browser 451. The external printer usage information provision setting completion page is a page for notifying that the external printer usage information provision setting is appropriately stored in the relay server 300. Accordingly, in step S320, the Web browser 451 displays the external printer usage information provision setting completion page on the display unit 420 of the first terminal device 400.

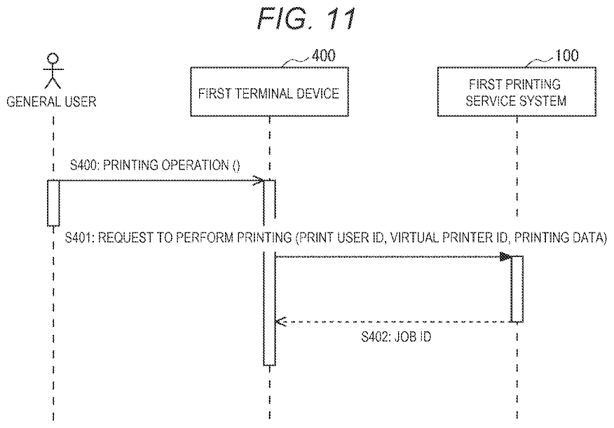

Next, a flow of a process in which the printing system 10 receives data to be printed will be described. Hereinafter, data to be printed is referred to as printing data. FIG. 11 is a sequence chart showing an example of a flow of a process of receiving the printing data by the printing system 10. Hereinafter, the flow of the process will be described with reference to FIG. 11.

In step S400, a general user performs, via the input unit 430 of the first terminal device 400, a predetermined operation for printing the printing data. Specifically, for example, the general user performs an operation of designating a virtual printer to be used for printing, printing data, and a printing setting. In the embodiment, the user designates the image forming device 600 to be used for printing by using the code image C attached to the image forming device 600. Therefore, in this step, the user designates the code virtual printer as the virtual printer to be used for printing. The printing setting designated in step S400 is a setting value set in the printer for printing. Examples of the printing setting include, but are not limited to, a setting value for designating a size of a sheet to be used, a setting value for designating whether to perform color printing, and a setting value for designating whether to perform double-sided printing. In the embodiment, a case in which the general user is an external user belonging to the second organization will be described, and the same applies to a case in which the general user is a user belonging to the first organization that owns the image forming device 600.

When the operation in step S400 is performed, in step S401, the printing request unit 452 of the first terminal device 400 requests the first printing service system 100 to perform printing. At this time, the printing request unit 452 transmits a user ID of the user who instructs printing in step S400, a virtual printer ID of the code virtual printer, the designated printing setting, and the designated printing data to the first printing service system 100. Then, the first printing service system 100 acquires these pieces of information.

Next, in step S402, the printing control unit 132 of the first printing service system 100 generates a printing job based on the information received in step S401, and notifies the first terminal device 400 of a job ID that is identification information of the printing job. The generated printing job remains stored in the first printing service system 100 until the user instructs printing after determining the image forming device 600 as an output destination using the code image C. At this time, the printing job is stored in the first printing service system 100 in association with the virtual printer ID of the code virtual printer and the user ID.

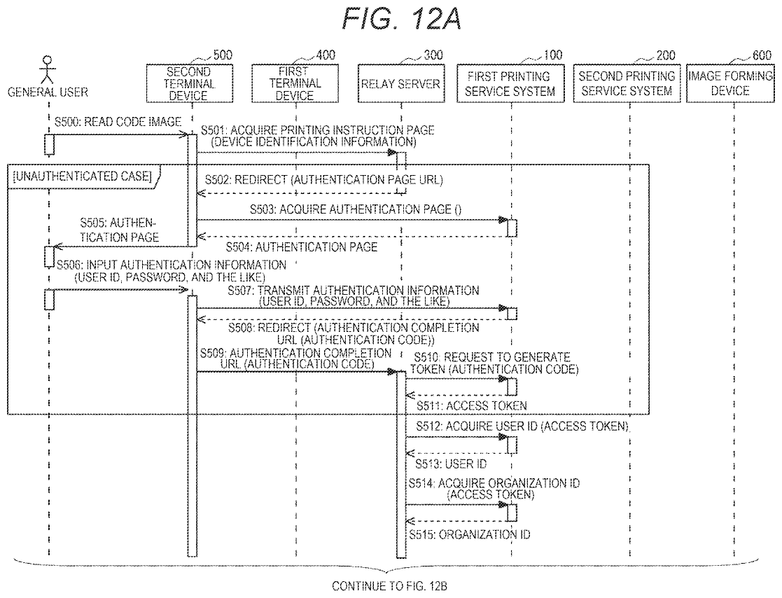

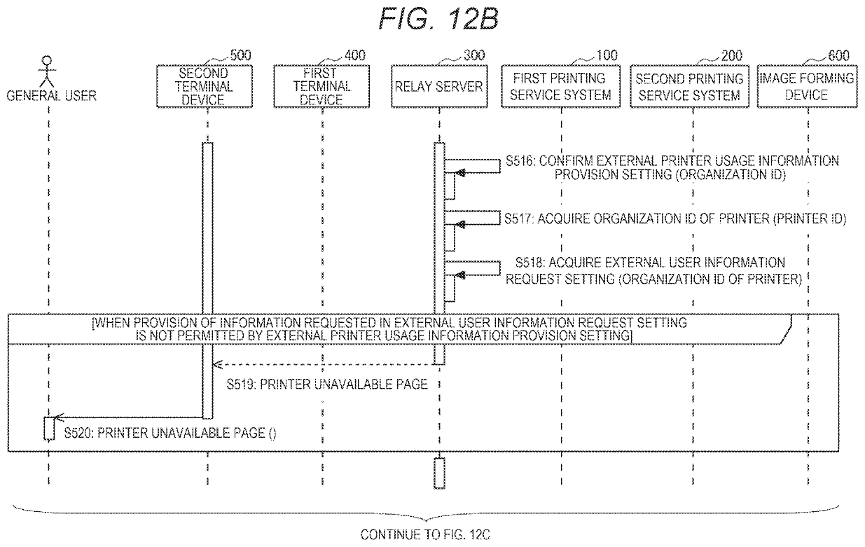

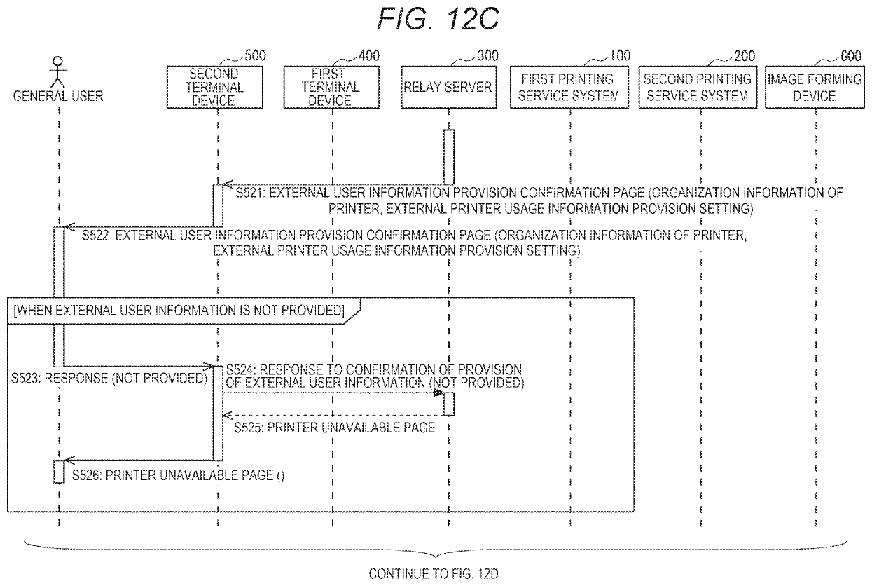

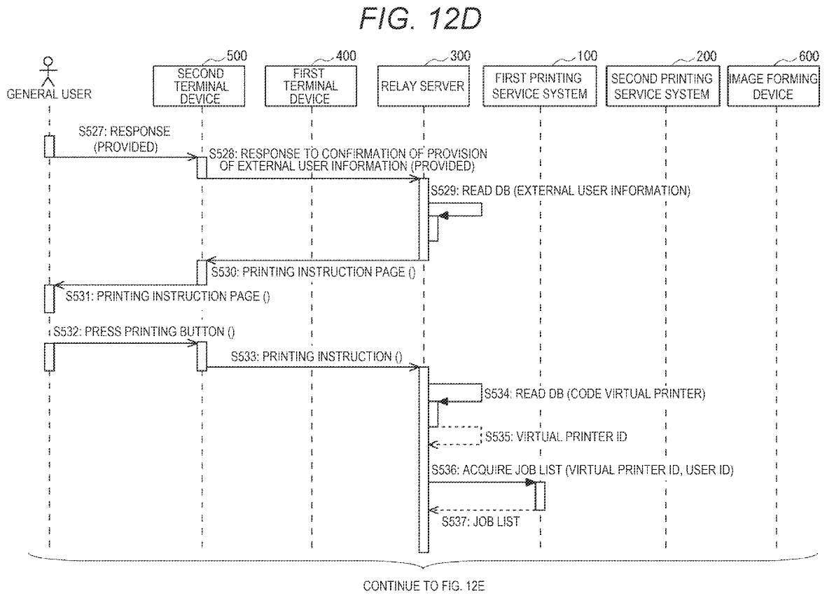

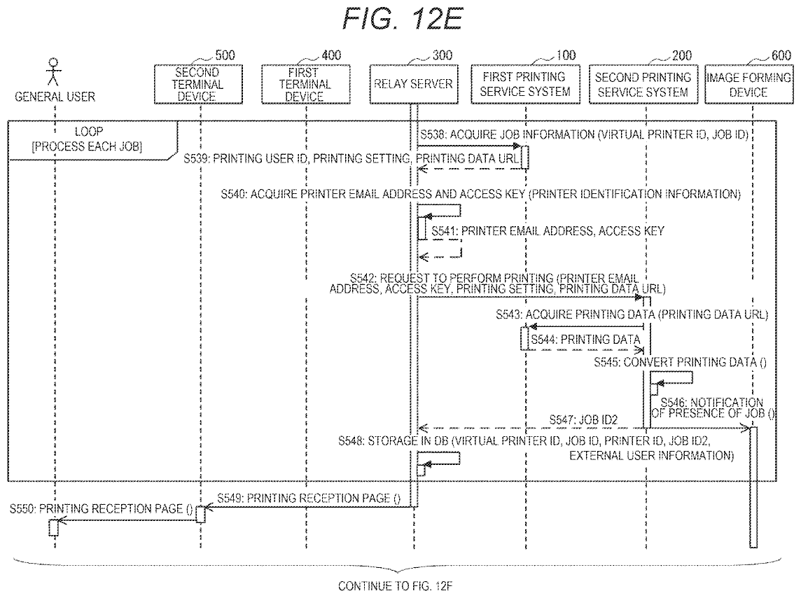

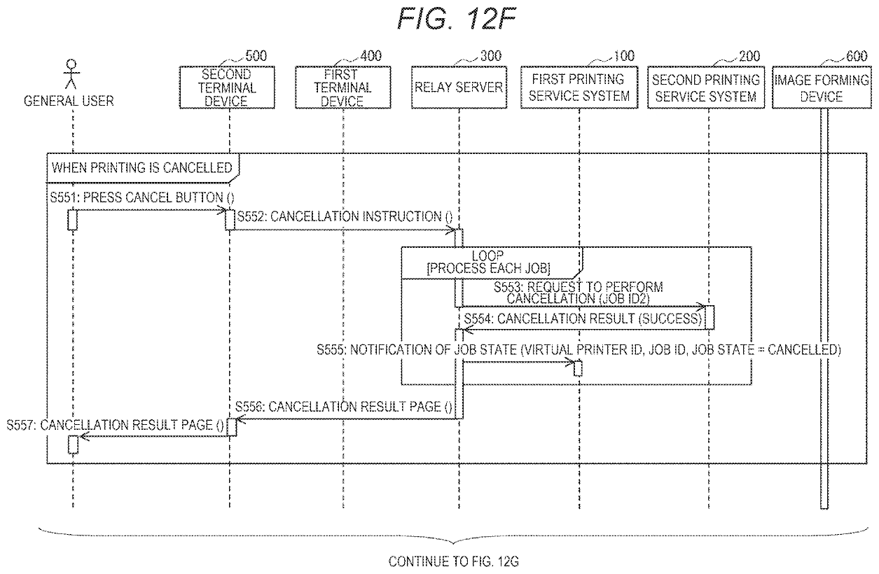

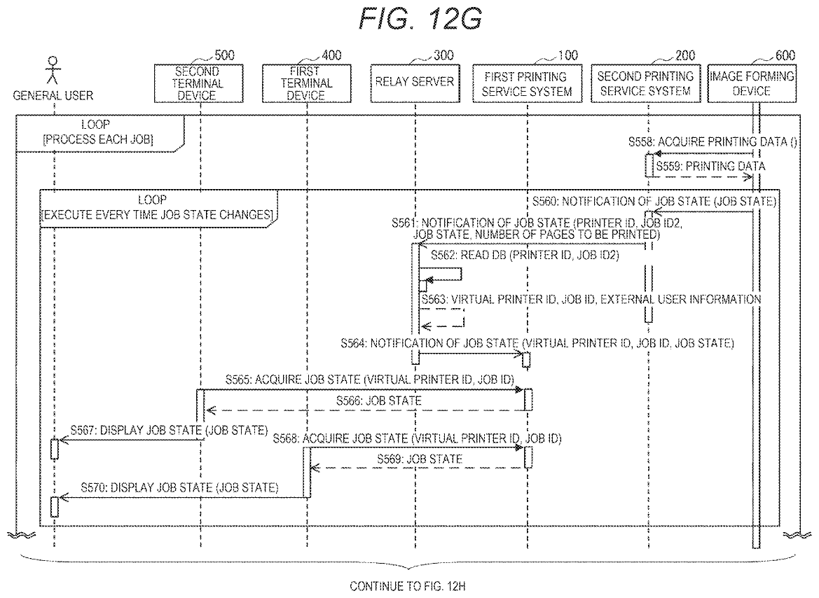

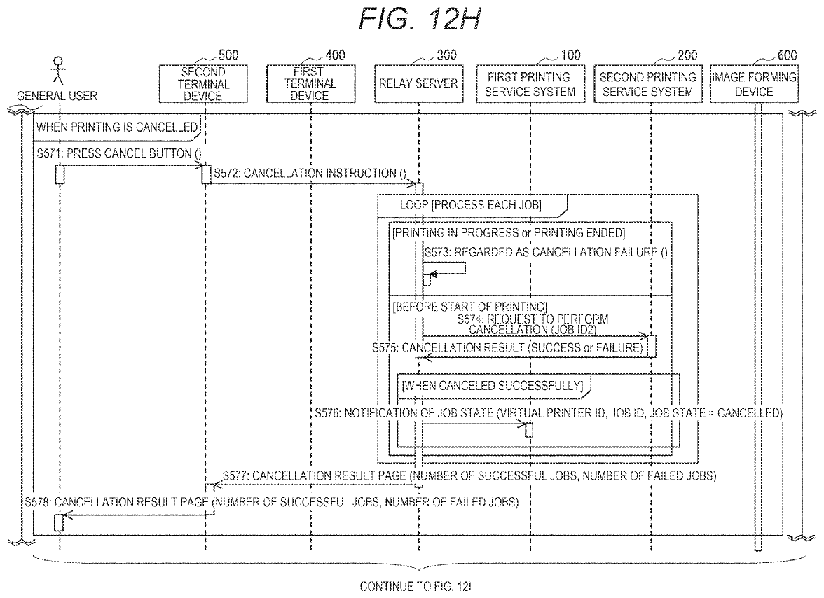

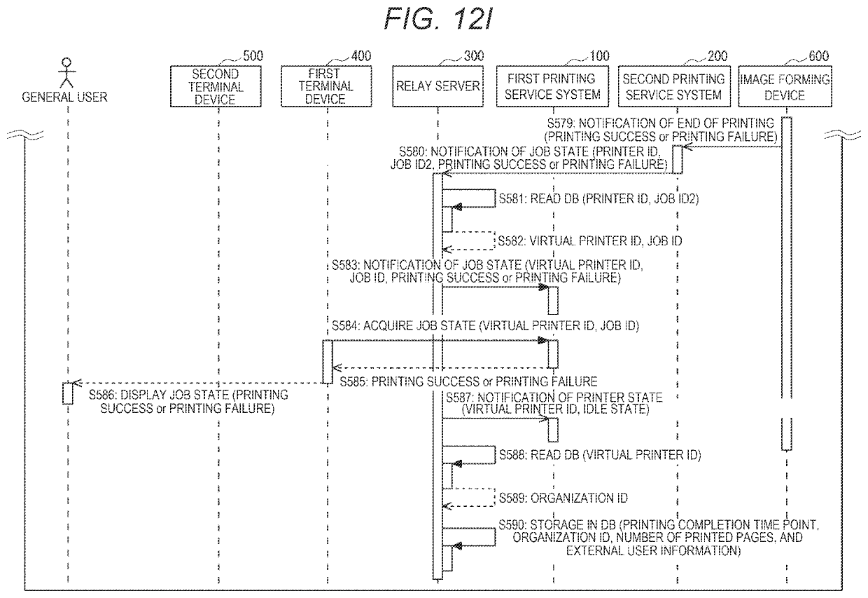

Next, a flow of a printing process when printing is performed by the user with the image forming device 600 specified by the code image C read by the second terminal device 500 will be described. FIGS. 12A to 121 are sequence charts showing an example of the flow of the printing process executed by the printing system 10. An order of processes of steps in the sequence chart is merely an example, and can be appropriately changed as long as there is no technical contradiction. Hereinafter, the flow of the printing process will be described with reference to FIGS. 12A to 121.

After performing the operation in step S400 shown in FIG. 11, the general user moves to the image forming device 600 from which a printed matter is desired to be acquired. Then, in step S500 shown in FIG. 12A, the general user uses the reading unit 550 of the second terminal device 500 to perform an operation of reading the code image C attached to the image forming device 600 from which the printed matter is desired to be acquired. The code image C includes device identification information, which is identification information on the image forming device 600, and a URL for accessing the relay server 300.

After step S500, in step S501, the Web browser 561 of the second terminal device 500 transmits, according to the URL obtained from the code image C, a request to acquire a printing instruction page to the relay server 300. Here, the printing instruction page is a page prepared for the user to instruct the relay server 300 to execute printing. At this time, the Web browser 561 transmits, to the relay server 300, the device identification information included in the code image C read by the reading unit 550 together with the request to acquire the printing instruction page. That is, in the embodiment, the identification information transmission unit 562 implemented as the Web browser 561 transmits the device identification information to the relay server 300. Accordingly, the device identification information acquisition unit 334 of the relay server 300 acquires the device identification information specifying the image forming device 600 used for printing.

In the embodiment, as described above, authentication printing is performed in the printing system 10. Therefore, in step S502 to step S511, user authentication using the authentication function of the first printing service system 100 is performed. When the authentication of the user who performs the operation in step S500 is already normally completed by the first printing service system 100, the processes in step S502 to step S511 may be omitted.

In step S502, the authentication control unit 331 of the relay server 300 instructs the Web browser 561 to access a predetermined redirect page. In this step, the predetermined redirect page is an authentication page. Therefore, the authentication control unit 331 of the relay server 300 transmits a URL of the authentication page to the Web browser 561 of the second terminal device 500. As can be seen from step S501 and step S502, the authentication control unit 331 notifies the second terminal device 500 of an access destination for transmitting the authentication information to the first printing service system 100 in response to the access from the second terminal device 500 based on the code image C read by the second terminal device 500. Accordingly, the second terminal device 500 can automatically obtain the access destination for authentication.

In step S503, the Web browser 561 of the second terminal device 500 transmits, according to the received URL, a request to acquire the authentication page to the first printing service system 100. In response to this, in step S504, the authentication control unit 131 of the first printing service system 100 transmits the authentication page to the Web browser 561. Accordingly, in step S505, the Web browser 561 displays the authentication page on the display unit 520 of the second terminal device 500.

In step S506, the user who performs the operation in step S500 inputs authentication information to the authentication page via the input unit 530. Specifically, for example, the user inputs his or her user ID, a password, and the like. Here, the required authentication information is authentication information used in the first printing service system 100, and specifically, is a user ID, a password, and the like registered in advance. In step S507, the Web browser 561 transmits the input authentication information to the first printing service system 100. The authentication control unit 131 of the first printing service system 100 performs an authentication process based on the authentication information received from the Web browser 561 of the second terminal device 500. That is, the authentication control unit 131 determines whether the received authentication information matches authentication information on the user registered in advance.

When the authentication is successful in the authentication process, that is, when the received authentication information matches the authentication information on the user registered in advance, in step S508, the authentication control unit 131 of the first printing service system 100 issues an authentication code and instructs the Web browser 561 to access a predetermined redirect destination. The predetermined redirect destination is the relay server 300. By this redirect, the authentication code is passed to the relay server 300. Therefore, the authentication control unit 131 of the first printing service system 100 transmits a URL indicating the predetermined redirect destination to the Web browser 561 of the second terminal device 500, together with the authentication code.

In step S509, the Web browser 561 of the second terminal device 500 accesses a predetermined redirect destination together with the authentication code. Accordingly, the relay server 300 acquires the authentication code. Then, in step S510, the authentication control unit 331 of the relay server 300 transmits a request to generate an access token to the first printing service system 100, together with the received authentication code. The access token is information certifying that the access is a valid access by the user of the first printing service system 100, that is, an access with a valid authority as a user, and corresponds to authentication completion information. That is, the access token indicates that the authentication performed by the first printing service system 100 for the authentication information on the user is completed. In step S511, after confirming that the authentication code received in step S510 matches the authentication code transmitted in step S508, the authentication control unit 131 of the first printing service system 100 issues an access token and transmits the access token to the relay server 300. Accordingly, the authentication control unit 331 of the relay server 300 acquires the access token, that is, the authentication completion information. When the authentication completion information is not obtained, the relay server 300 ends the process without executing subsequent processes.

Next, in step S512, the printing control unit 335 of the relay server 300 transmits a request to acquire the user ID of the user who performs the operation in step S500 to the first printing service system 100, together with the access token acquired in step S511. In response to this, in step S513, when the authentication control unit 131 confirms that the access token received in step S512 is valid, the information management unit 133 of the first printing service system 100 transmits the user ID to the relay server 300. Specifically, the information management unit 133 transmits the user ID managed by the first printing service system 100 to the relay server 300. Accordingly, the printing control unit 335 of the relay server 300 acquires the user ID of the user who performs the operation in step S500.

Next, in step S514, the printing control unit 335 of the relay server 300 transmits a request to acquire an organization ID of the user who performs the operation in step S500 to the first printing service system 100, together with the access token acquired in step S511. The organization ID of the user is identification information on a user organization to which the user belongs. For example, when the user is an external user who belongs to the second organization, the organization ID of the user is the organization ID of the second organization.

Next, in step 516, the printing control unit 335 reads an external printer usage information provision setting stored in advance. Specifically, the printing control unit 335 reads, from among the external printer usage information provision settings stored in the storage unit 310, an external printer usage information provision setting associated with the organization ID of the external user acquired in step S515. That is, the external printer usage information provision setting is a setting related to information that can be provided when the user belonging to the second organization uses the external image forming device 600.

In step S517, the printing control unit 335 acquires an organization ID of an organization to which the image forming device 600 intended to be used by the external user belongs. Specifically, the printing control unit 335 reads the device identification information included in the code image C of the image forming device 600 read by the external user, that is, the organization ID associated with the printer ID. In the embodiment, the image forming device 600 belongs to the first organization, and therefore, the organization ID associated with the printer ID is an organization ID of the first organization.

Next, in step S518, the printing control unit 335 reads an external user information request setting stored in advance. Specifically, the printing control unit 335 reads, from among the external user information request settings stored in the storage unit 310, an external user information request setting associated with the organization ID acquired in step S517. That is, the external user information request setting is a setting related to information to be provided by the external user when the external user uses the image forming device 600 belonging to the first organization.

When the provision of the information requested in the external user information request setting is not permitted by the external printer usage information provision setting, the external user is not permitted to use the image forming device 600. Therefore, in this case, in step S519, the printing control unit 335 of the relay server 300 transmits a printer unavailable page to the Web browser 561. Accordingly, in step S520, the Web browser 561 displays the printer unavailable page on the display unit 520 of the second terminal device 500. The printer unavailable page is a page for notifying that the use of the image forming device 600 identified by the device identification information acquired in step S501 is prohibited.

On the other hand, when the provision of the information requested by the external user information request setting is permitted by the external printer usage information provision setting, the printing control unit 335 of the relay server 300 transmits an external user information provision confirmation page to the Web browser 561 in step S521. Accordingly, in step S522, the Web browser 561 displays the external user information provision confirmation page on the display unit 520 of the second terminal device 500. The external user information provision confirmation page displays organization information on the image forming device 600 intended to be used by the external user and information on the external printer usage information provision setting.

When the external user does not provide the external printer usage information, in step S523, the external user inputs, to the external user information provision confirmation page via the input unit 530, a response indicating that the information is not provided. In step S524, the Web browser 561 transmits, to the printing control unit 335 of the relay server 300, the response indicating that the information is not provided as a response to confirmation of provision of the external user information. In this case, in step S525, the printing control unit 335 of the relay server 300 transmits the printer unavailable page to the Web browser 561. Accordingly, in step S526, the Web browser 561 displays the printer unavailable page on the display unit 520 of the second terminal device 500.

On the other hand, when the external user provides the external printer usage information, in step S527, the external user inputs, to the external user information provision confirmation page via the input unit 530, a response indicating that the information is provided. In step S528, the Web browser 561 transmits, to the printing control unit 335 of the relay server 300, the response indicating that the information is provided as a response to confirmation of provision of the external user information. In this case, in step 529, the printing control unit 335 reads external user information stored in advance. Specifically, the printing control unit 335 reads, from among a plurality of pieces of external user information stored in the storage unit 310, external user information associated with the user ID acquired in step S513.

Then, in step S530, the printing control unit 335 of the relay server 300 transmits the printing instruction page to the Web browser 561. Accordingly, in step S531, the Web browser 561 displays the printing instruction page on the display unit 520 of the second terminal device 500. The printing instruction page is a page for receiving a printing instruction from the user. For example, a printing button, which is a button for the user to instruct the printing system 10 to execute printing, is disposed on the printing instruction page. In step S532, the user presses the printing button displayed on the printing instruction page. In step S533, the Web browser 561 transmits an instruction to execute printing to the relay server 300. That is, in the embodiment, the instruction transmission unit 563 implemented as the Web browser 561 transmits the instruction to execute printing. Accordingly, the printing control unit 335 of the relay server 300 receives the instruction to execute printing.

When the relay server 300 receives the instruction to execute printing, in step S534, the printing control unit 335 of the relay server 300 performs a process of reading a database of the storage unit 310 or the like in order to acquire the virtual printer ID of the code virtual printer. Accordingly, in step S535, the printing control unit 335 reads the virtual printer ID of the code virtual printer.

Next, in step S536, the printing control unit 335 of the relay server 300 acquires a list of printing jobs for printing data to be printed by the image forming device 600 identified by the device identification information included in the code image C. Specifically, the printing control unit 335 transmits a request to acquire the job list to the first printing service system 100. More specifically, the printing control unit 335 transmits the request together with the virtual printer ID acquired in step S535 and the user ID acquired in step S513. In response to this, in step S537, the printing control unit 132 of the first printing service system 100 transmits the list of printing jobs stored in the first printing service system 100 to the relay server 300. That is, the printing control unit 132 of the first printing service system 100 transmits the job list for the printing jobs that are associated with the code virtual printer and also associated with the received user ID. When the job list is transmitted from the first printing service system 100, the processes in step S538 to step S548 are performed for each printing job listed in the job list.

In step S538, the printing control unit 335 of the relay server 300 transmits a request to acquire job information to the first printing service system 100. Specifically, the printing control unit 335 transmits the request together with the virtual printer ID notified in step S535 and the job ID listed in the job list acquired in step S537. In response to this, in step S539, the printing control unit 132 of the first printing service system 100 transmits, to the relay server 300, the user ID of the user who is going to execute the printing corresponding to the job ID, the printing setting corresponding to the job ID, and the URL indicating a storage location of the printing data corresponding to the job ID as the job information. In the following description, the URL indicating the storage location of the printing data is referred to as a printing data URL.

When the relay server 300 receives the job information, in step S540, the printing control unit 335 of the relay server 300 performs a process of reading the database of the storage unit 310 or the like in order to acquire information required for access to the image forming device 600 identified by the device identification information included in the code image C. Accordingly, in step S541, the printing control unit 335 reads the information required for access. In the embodiment, the information required to access the image forming device 600 is, specifically, a printer email address assigned in advance to the image forming device 600 identified by the device identification information included in the code image C and an access key such as a password. These pieces of information are stored in advance in a database of the storage unit 310 of the relay server 300. When these pieces of information are not required for accessing the image forming device 600, step S540 and step S541 may be omitted.

Next, in step S542, the printing control unit 335 of the relay server 300 requests the second printing service system 200 to perform printing. At this time, the printing control unit 335 transmits the printer email address and the access key read in step S541 and the printing setting and the printing data URL acquired in step S539 to the second printing service system 200. As described above, the printing control unit 335 requests the second printing service system 200 to perform printing by the image forming device 600 identified by the device identification information included in the code image C.

As described above, when acquiring a printing instruction from the second terminal device 500, the printing control unit 335 acquires a printing job from the first printing service system 100 and transmits, to the second printing service system 200, a request to cause the image forming device 600 to execute printing for the printing job. Accordingly, in a system in which the first printing service system 100 and the second printing service system 200 cooperate with each other, the image forming device 600 can perform printing. In the flow of the process described above, the user gives a batch printing instruction to one or more printing jobs, and may give an individual printing instruction. In this case, the printing control unit 335 acquires the list of printing jobs from the first printing service system 100, transmits the list to the second terminal device 500, acquires, from the second terminal device 500, the printing instruction for the printing job selected from the list, and acquires the selected printing job from the first printing service system 100. According to such a configuration, the user can select whether to perform printing for each printing job, and therefore, convenience for the user is improved.

Here, a process for the relay server 300 to acquire the printing job from the first printing service system 100 will be further described. In the above description, from step S536 to step S539, the process for the relay server 300 to acquire the printing job from the first printing service system 100 is performed. An access token may be required during these processes. That is, in step S536, the printing control unit 335 of the relay server 300 may transmit a request to acquire a job list to the first printing service system 100, together with the access token acquired in step S511. Then, in step S537, when the authentication control unit 131 confirms that the received access token is valid, the printing control unit 132 of the first printing service system 100 may transmit the job list to the relay server 300. Similarly, in step S538, the printing control unit 335 of the relay server 300 may transmit a request to acquire job information to the first printing service system 100, together with the access token acquired in step S511. Then, in step S539, when the authentication control unit 131 confirms that the received access token is valid, the printing control unit 132 of the first printing service system 100 may transmit the job information to the relay server 300. As described above, the printing control unit 335 may acquire the printing job for the user from the first printing service system 100 using the access token corresponding to the authentication completion information, and transmit, to the second printing service system 200, a request to cause the image forming device 600 to execute printing for the printing job. As described above, when the authentication of the user is not normally completed in a case in which the authentication completion information is required to acquire the printing job, the printing control unit 335 interrupts the process. Therefore, unauthorized use of the system can be prevented. It can be interpreted that even if the access token is not required in the processes in step S536 to step S539, in the embodiment, the printing control unit 335 uses the authentication completion information to acquire the printing job for the user from the first printing service system 100. This is because the user ID (see step S512 and step S513), which is information acquired only when it is confirmed that the access token is valid in step S536 and step S537, is required.

When the second printing service system 200 receives the printing request from the relay server 300, in step S543, the printing control unit 231 of the second printing service system 200 accesses the printing data URL notified in step S542 in order to acquire the printing data. In step S544, the printing control unit 231 of the second printing service system 200 acquires the printing data from the first printing service system 100.

After step S544, in step S545, the printing control unit 231 converts the printing data acquired in step S544 into printing data conforming to a predetermined printer language. Thereafter, in step S546, the printing control unit 231 notifies the image forming device 600, which is a printer used for printing, of presence of a printing job for printing the converted printing data. The printing job is a printing job corresponding to the printing job managed by the first printing service system 100, and is a printing job managed by the printing control unit 231 of the second printing service system 200. Therefore, a new ID is assigned in addition to the job ID value described above. Hereinafter, the ID of the printing job managed by the printing control unit 231 of the second printing service system 200 is referred to as a job ID2. In step S547, the printing control unit 231 of the second printing service system 200 notifies the relay server 300 of the job ID2. In response to this, in step S548, the printing control unit 335 of the relay server 300 performs a process of storing a correspondence relationship between the printing job of the first printing service system 100 and the printing job of the second printing service system 200. Specifically, the printing control unit 335 stores the virtual printer ID, the job ID of the first printing service system 100, the device identification information (printer ID) of the image forming device 600 used for printing, the job ID of the second printing service system 200, that is, the job ID2, and the external user information, which is information on the user who executes printing, in association with each other in the database of the storage unit 310 or the like.

When the processes in step S538 to step S548 are performed for all the printing jobs listed in the job list acquired in step S537, the process proceeds to step S549. In step S549, the printing control unit 335 of the relay server 300 transmits a printing reception page to the Web browser 561. Accordingly, in step S550, the Web browser 561 displays the printing reception page on the display unit 520 of the second terminal device 500. The printing reception page is a page for notifying that the printing instruction from the user is normally received. The printing reception page is also a page for receiving a printing cancellation instruction from the user. Therefore, a cancel button, which is a button for the user to instruct the printing system 10 to cancel printing, is disposed on the printing reception page. The user can press the cancel button displayed on the printing reception page as necessary. Hereinafter, the processes (step S551 to step S557) executed in the printing system 10 when the cancel button is pressed by the user before the processes in step S558 and subsequent steps to be described later are started will be described.

The user who desires to cancel printing presses the cancel button displayed on the printing reception page in step S551. In step S552, the Web browser 561 transmits the printing cancellation instruction to the relay server 300. That is, in the embodiment, the instruction transmission unit 563 implemented as the Web browser 561 transmits the printing cancellation instruction. Accordingly, the relay server 300 receives the printing cancellation instruction.

When the relay server 300 receives the printing cancellation instruction, the processes in step S553 to step S555 are performed for each printing job. In step S553, the printing control unit 335 of the relay server 300 designates a printing job according to the job ID2 and requests the second printing service system 200 to cancel the process of the printing job. At this time point, since the printing process performed by the image forming device 600 is not started yet, the printing control unit 231 of the second printing service system 200 cancels the printing job in step S554. Then, the printing control unit 231 transmits a cancellation result indicating that the printing job is successfully cancelled to the relay server 300. When the relay server 300 receives the cancellation result from the second printing service system 200, in step S555, the printing control unit 335 of the relay server 300 notifies the first printing service system 100 of the job state together with the virtual printer ID of the code virtual printer and the job ID to be cancelled. Specifically, the printing control unit 335 notifies the first printing service system 100 of a job state indicating that cancellation is performed. As described above, when acquiring the cancellation result (that is, the job state) from the second printing service system 200, the printing control unit 335 transmits the job state to the first printing service system 100.

When the processes in step S553 to step S555 are performed for all the printing jobs to be cancelled, the process proceeds to step S556. In step S556, the printing control unit 335 of the relay server 300 transmits a cancellation result page to the Web browser 561. Accordingly, in step S557, the Web browser 561 displays the cancellation result page on the display unit 520 of the second terminal device 500. The cancellation result page is a page for notifying whether the process of each printing job is cancelled in response to the printing cancellation instruction from the user. That is, the cancellation result page is a page for notifying whether the cancellation of printing is normally performed. At a time point when the printing process performed by the image forming device 600 is not started, the printing is successfully canceled, and thus the cancellation result page indicating that the printing is successfully canceled is displayed in step S557. The cancellation result page transmitted in step S556 may include the number of printing jobs for which the printing is successfully canceled and the number of printing jobs for which the printing is failed to be canceled.

When the cancel button is not pressed before the processes in step S558 and the subsequent steps are started, the processes in step S558 to step S590 are performed for each printing job.

In step S558, the printing processing unit 641 of the image forming device 600 corresponding to the device identification information included in the code image C transmits a request to acquire printing data to the second printing service system 200. In response to this, in step S559, the printing control unit 231 of the second printing service system 200 transmits the converted printing data to the image forming device 600.

After step S559, the processes in step S560 to step S570 are executed every time the job state changes. These processes are executed when the printing process is started in the image forming device 600 or when an error occurs after the printing process is started.

In step S560, the printing processing unit 641 of the image forming device 600 notifies the second printing service system 200 of the job state. When the second printing service system 200 receives this notification, in step S561, the printing control unit 231 of the second printing service system 200 notifies the relay server 300 of the job state notified in step S560 together with the printer ID and the job ID2. Accordingly, the printing control unit 335 of the relay server 300 acquires the job state and the number of pages to be printed regarding the printing process performed by the image forming device 600.

When the relay server 300 receives the notification of the job state, in step S562, the printing control unit 335 of the relay server 300 performs a process of reading the database of the storage unit 310 or the like to acquire information stored in association with the received printer ID and job ID2. Accordingly, in step S563, the printing control unit 335 reads the virtual printer ID, the job ID, and the external user information stored in association with the printer ID and the job ID2. Then, in step S564, the printing control unit 335 of the relay server 300 notifies the first printing service system 100 of the job state notified in step S561 together with the virtual printer ID and the job ID. That is, when acquiring the job state from the second printing service system 200, the printing control unit 335 transmits the job state to the first printing service system 100.

In step S565, the state output unit 564 of the second terminal device 500 transmits a request to acquire job information to the first printing service system 100 by designating the virtual printer ID and the job ID. In response to this, in step S566, the printing control unit 132 of the first printing service system 100 transmits the job state received in step S564 to the second terminal device 500. Accordingly, in step S567, the state output unit 564 of the second terminal device 500 displays the job state on the display unit 520 of the second terminal device 500.

The job state may be displayed on the first terminal device 400. In this case, in step S568, the state output unit 453 of the first terminal device 400 transmits a request to acquire job information to the first printing service system 100 by specifying the virtual printer ID and the job ID. In response to this, in step S569, the printing control unit 132 of the first printing service system 100 transmits the job state received in step S564 to the first terminal device 400. Accordingly, in step S570, the state output unit 453 of the first terminal device 400 displays the job state on the display unit 420 of the first terminal device 400.

As can be seen from this sequence chart, every time the job state is updated, the printing control unit 335 of the relay server 300 transmits an updated job state to the first printing service system 100. Therefore, the user can appropriately grasp a current job state via the first printing service system 100.

Next, processes (step S571 to step S578) executed in the printing system 10 when the cancel button is pressed after the process in step S558 is started will be described.

The user who desires to cancel printing presses the cancel button displayed on the printing reception page in step S571. In step S572, the Web browser 561 transmits the printing cancellation instruction to the relay server 300. That is, in the embodiment, the instruction transmission unit 563 implemented as the Web browser 561 transmits the printing cancellation instruction. Accordingly, the relay server 300 receives the printing cancellation instruction.

When the relay server 300 receives the printing cancellation instruction, the processes in step S573 to step S576 are performed for each printing job. Here, when the job state, of which the relay server 300 is notified by the second printing service system 200, for the printing job to be cancelled is printing in progress or printing ended, the process in step S573 is performed. In step S573, the printing control unit 335 of the relay server 300 regards the cancellation of the printing process to be failed for the printing job. On the other hand, when the job state, of which the relay server 300 is notified by the second printing service system 200, for the printing job to be cancelled is the state before the start of printing, the processes in step S574 and step S575 are performed. In step S574, the printing control unit 335 of the relay server 300 designates the printing job by the job ID2 and requests the second printing service system 200 to cancel the process for the printing job. In response to this, when the image forming device 600 does not start the printing for the printing job, the printing control unit 231 of the second printing service system 200 cancels the printing job in step S575. Then, the printing control unit 231 transmits a cancellation result indicating that the printing job is successfully cancelled to the relay server 300. However, there may be a case in which the printing for the printing job is already started by the image forming device 600. For example, such a case may occur due to a time lag in notifying the relay server 300 of the latest job state. In this case, in step S575, the printing control unit 231 of the second printing service system 200 fails to cancel the printing job and transmits a cancellation result indicating that the printing job is failed to be cancelled to the relay server 300. When the printing control unit 335 of the relay server 300 receives the cancellation result indicating that the printing job is successfully cancelled from the second printing service system 200, in step S576, the printing control unit 335 notifies the first printing service system 100 of the job state together with the virtual printer ID of the code virtual printer and the job ID to be cancelled. Specifically, the printing control unit 335 notifies the first printing service system 100 of a job state indicating that cancellation is performed.

When the processes in step S573 and the subsequent steps are performed for all the printing jobs to be cancelled, the process proceeds to step S577. In step S577, the printing control unit 335 of the relay server 300 transmits a cancellation result page to the Web browser 561. The cancellation result page includes the number of printing jobs for which the printing is successfully cancelled and the number of printing jobs for which the printing is failed to be cancelled. Then, in step S578, the Web browser 561 displays the cancellation result page on the display unit 520 of the second terminal device 500.

When the cancel button is not pressed after the process in step S558 is started, the processes in step S579 and subsequent steps are performed after the processes in step S560 to step S570 described above.

In step S579, when the printing process for the printing job is ended, the printing processing unit 641 of the image forming device 600 notifies the second printing service system 200 of the end of the printing by notifying a processing result of the printing job. Specifically, the printing processing unit 641 notifies whether the printing processing is normally completed. That is, the printing processing unit 641 notifies whether the printing is successful or failed. When the second printing service system 200 receives this notification, in step S580, the printing control unit 231 of the second printing service system 200 notifies the relay server 300 of the processing result notified in step S579 as the job state, together with the printer ID and the job ID2. Accordingly, the printing control unit 335 of the relay server 300 acquires the job state of the printing process performed by the image forming device 600.

When the relay server 300 receives the notification of the job state, in step S581, the printing control unit 335 of the relay server 300 performs a process of reading the database of the storage unit 310 or the like to acquire information stored in association with the received printer ID and job ID2. Accordingly, in step S582, the printing control unit 335 reads the virtual printer ID and the job ID stored in association with the virtual printer ID and the job ID.

Next, in step S583, the printing control unit 335 of the relay server 300 notifies the first printing service system 100 of the job state together with the virtual printer ID and the job ID. That is, when acquiring the job state from the second printing service system 200, the printing control unit 335 transmits the job state to the first printing service system 100.

In step S584, the state output unit 453 of the first terminal device 400 transmits a request to acquire job information to the first printing service system 100 by designating the virtual printer ID and the job ID. In response to this, in step S585, the printing control unit 132 of the first printing service system 100 transmits the job state received in step S583 to the first terminal device 400. Accordingly, in step S586, the state output unit 453 of the first terminal device 400 displays the job state on the display unit 420 of the first terminal device 400.

The job state may be displayed on the second terminal device 500. In this case, the state output unit 564 of the second terminal device 500 transmits a request to acquire job information to the first printing service system 100 by designating the virtual printer ID and the job ID. In response to this, the printing control unit 132 of the first printing service system 100 transmits the job state received in step S583 to the second terminal device 500. Accordingly, the state output unit 564 of the second terminal device 500 displays the job state on the display unit 520 of the second terminal device 500.

Thereafter, in step S587, the printing control unit 335 of the relay server 300 notifies the first printing service system 100 that the printer state is the idle state together with the virtual printer ID.

In step S588, the printing control unit 335 of the relay server 300 performs a process of reading the database of the storage unit 310 or the like in order to acquire information stored in association with the virtual printer ID and read in step S582. Accordingly, in step S589, the printing control unit 335 reads an organization ID stored in association with the virtual printer ID. That is, in step S125 of FIG. 8B, the registration unit 332 of the relay server 300 stores, in the database of the storage unit 310 or the like, the virtual printer ID of the virtual printer registered as the code virtual printer and the organization ID of the organization to which the virtual printer ID belongs. In step S589, the printing control unit 335 reads the organization ID corresponding to the virtual printer ID stored in the database of the storage unit 310 or the like. Here, the organization ID stored in association with the virtual printer ID corresponds to the organization ID of the organization to which the image forming device 600 belongs, and is the organization ID of the first organization in this case.

Next, in step S590, the printing control unit 335 of the relay server 300 stores the printing completion time point, the organization ID, the number of pages to be printed, and the external user information in the database of the storage unit 310 or the like. Here, the printing completion time point can be determined, for example, based on the job state notification acquired by the relay server 300 from the second printing service system 200 in step S580. The organization ID is the organization ID of the organization to which the image forming device 600 belongs, and the organization ID acquired in step S589 can be used. The number of pages to be printed can be determined, for example, based on the job state notification acquired by the relay server 300 from the second printing service system 200 in step S561. As the external user information, for example, the external user information read by the printing control unit 335 in step S563 can be used. A timing at which the printing completion time point, the organization ID, the number of pages to be printed, and the external user information described above are acquired is an example. In the present embodiment, information acquired at a timing other than the above timing may be used.

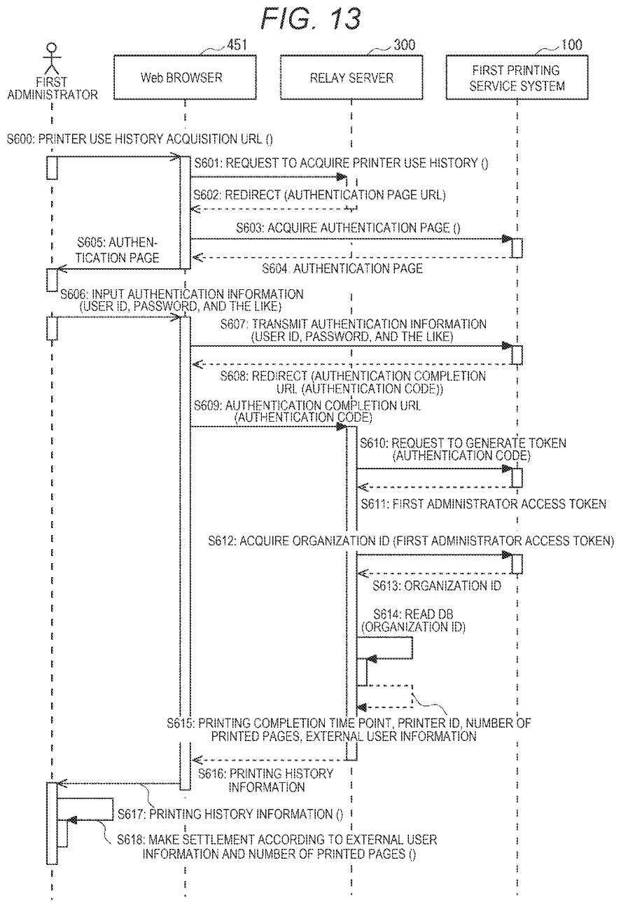

Next, a flow of the printer use history acquisition process is described using a sequence chart shown in FIG. 13. A case in which the first administrator of the first organization who manages the image forming device 600 acquires a printer use history will be described below. That is, the first administrator can adjust, by acquiring the printer use history of the image forming device 600, a use fee for using the image forming device 600 by the external user.

As shown in FIG. 13, first, in step S600, the first administrator performs a predetermined operation for starting the printer use history acquisition process via the input unit 430 of the first terminal device 400. Accordingly, a URL of the printer use history acquisition page is input to the Web browser 451 of the first terminal device 400. Here, the printer use history acquisition page is a page prepared to acquire a printer use history from the relay server 300. After step S600, in step S601, the Web browser 451 transmits, according to the input URL, a request to acquire the printer use history acquisition page to the relay server 300. In response to this, in step S602, the authentication control unit 331 of the relay server 300 instructs the Web browser 451 to access a predetermined redirect page. In this step, the predetermined redirect page is an authentication page. Therefore, the authentication control unit 331 of the relay server 300 transmits a URL of the authentication page to the Web browser 451. The authentication page is a page for requesting the user to input authentication information.

In step S603, the Web browser 451 transmits, according to the received URL, a request to acquire the authentication page to the first printing service system 100. In response to this, in step S604, the authentication control unit 131 of the first printing service system 100 transmits the authentication page to the Web browser 451. Accordingly, in step S605, the Web browser 451 displays the authentication page on the display unit 420 of the first terminal device 400.

In step S606, the first administrator inputs authentication information to the authentication page via the input unit 430. Specifically, for example, the first administrator inputs a user ID, a password, and the like of the first administrator. Here, the required authentication information is authentication information used in the first printing service system 100, and specifically, is a user ID, a password, and the like registered in advance. In step S607, the Web browser 451 transmits the input authentication information to the first printing service system 100. The authentication control unit 131 of the first printing service system 100 performs an authentication process based on the authentication information received from the Web browser 451. That is, the authentication control unit 131 determines whether the received authentication information matches authentication information on the first administrator that is registered in advance.

When the authentication is successful in the authentication process, that is, when the received authentication information matches the authentication information on the first administrator registered in advance, in step S608, the authentication control unit 131 of the first printing service system 100 issues an authentication code and further instructs the Web browser 451 to access a predetermined redirect destination. The predetermined redirect destination is the relay server 300. By this redirect, the authentication code is passed to the relay server 300. Therefore, the authentication control unit 131 of the first printing service system 100 transmits a URL indicating the predetermined redirect destination to the Web browser 451, together with the authentication code.

In step S609, the Web browser 451 accesses the predetermined redirect destination together with the authentication code. Accordingly, the relay server 300 acquires the authentication code. Then, in step S610, the authentication control unit 331 of the relay server 300 transmits a request to request generation of a first administrator access token to the first printing service system 100, together with the received authentication code. The first administrator access token is information certifying that the access is a valid access of the first administrator, that is, an access with a valid authority as the first administrator. In step S611, after confirming that the authentication code received in step S610 matches the authentication code transmitted in step S608, the authentication control unit 131 of the first printing service system 100 issues a first administrator access token and transmits the first administrator access token to the relay server 300. In step S612, the authentication control unit 331 of the relay server 300 transmits a request for acquiring the organization ID of the first administrator to the first printing service system 100, together with the first administrator access token. In step S613, the authentication control unit 131 of the first printing service system 100 transmits information on the organization ID corresponding to the first administrator access token to the relay server 300.

Thereafter, in step S614, the printing history information acquisition unit 336 of the relay server 300 performs a process of reading the database of the storage unit 310 or the like in order to acquire the printing history information stored in association with the organization ID acquired in step S613. Accordingly, in step S615, the printing history information acquisition unit 336 reads the printing history information stored in association with the organization ID, such as the printing completion time point, the printer ID, the number of printed pages, and the external user information.

Thereafter, in step S616, the printing history information acquisition unit 336 transmits a page for displaying the printing history information to the Web browser 451. Accordingly, in step S617, the Web browser 451 displays the printing history information on the display unit 420 of the first terminal device 400.

Thereafter, in step S618, the first administrator settles the cost according to the external user information and the number of printed pages. That is, the printing history information includes the external user information, and therefore, the first administrator can extract the printing history information on the external user from the printing history information. Therefore, the first administrator can calculate, based on the extracted printing history information on the external user, the printing cost for which the external user is charged.

In the embodiment, the printing system 10 may include a cost settlement device. In this case, when receiving a printing history information request to request the printing history information from the cost settlement device, the relay server 300 may transmit the printing history information to the cost settlement device. Accordingly, the cost settlement device can calculate a cost of using the image forming device 600 and charge the second administrator of the second organization, which is the organization of the external user, for the cost of using the image forming device 600. The cost of using the image forming device 600 can be calculated by the relay server 300, or may be calculated by the first terminal device 400 or the cost settlement device. Accordingly, even when the external user uses the printing system, the external user can be easily charged for the printing cost.

The printing system 10 according to the embodiment has been described above. According to the printing system 10, authentication printing using authentication performed by the first printing service system 100 is implemented in a printing system in which different systems providing printing services cooperate with each other. Therefore, unauthorized use of the system can be prevented. Even when the second printing service system 200 does not have an authentication function, the authentication printing can be implemented in printing by the image forming device 600 connected to the second printing service system 200. Further, according to the printing system 10, even in the printing system in which different systems providing printing service cooperate with each other, the user can designate the image forming device 600 to be used for printing by using the code image C attached to the image forming device 600. Therefore, erroneous selection of the image forming device 600 to be used can be reduced, as compared with a case in which the user selects the image forming device 600 to be used on the screen. Therefore, the user convenience is improved.

In the embodiment, the printing history information is stored in the storage unit 310 of the relay server 300. The printing history information includes the external user information, and therefore, the first administrator who manages the image forming device 600 can extract, based on the extracted printing history information on the external user, the printing history information on the external user from the printing history information and calculate the printing cost for which the external user is charged. Accordingly, the first administrator who manages the image forming device 600 can easily charge the second administrator of the second organization that is the organization of the external user for the printing cost of the image forming device 600.

The present disclosure is not limited to the embodiment described above, and can be appropriately modified without departing from the scope of the present disclosure. For example, the relay server 300 may be provided in the second printing service system 200. According to this configuration, for example, the same vendor can easily manage the relay server 300 and the second printing service system 200. In the embodiment described above, the second printing service system 200 acquires the printing data from the first printing service system 100, and the relay server 300 may acquire the printing data from the first printing service system 100 and transmit the printing data to the second printing service system 200. In the embodiment described above, the relay server 300 performs a process for enabling designation of the image forming device 600 using the code image C in order to perform printing by the image forming device 600 connected to the second printing service system 200. However, the relay server 300 may perform a process of enabling designation of the image forming device using the code image C in order to perform printing by the image forming device connected to the first printing service system 100. In this case, the relay server 300 may perform, with the first printing service system 100, the process described in the embodiment as the process performed with the second printing service system 200. In the embodiment described above, the printing system 10 includes a technique for implementing authentication printing and a technique for designating an image forming device using a code image, and a printing system including only one of the techniques may be provided.

In the above-described example, the program includes an instruction group (or a software code) for causing the computer to perform one or more functions described in the embodiment when the program is read by the computer. The program may be stored in a non-transitory computer-readable medium or a tangible storage medium. Examples of a computer-readable medium or a tangible storage medium include, but are not limited to, a random-access memory (RAM), a read-only memory (ROM), a flash memory, a solid-state drive (SSD), other memory techniques, a CD-ROM, a digital versatile disk (DVD), a Blu-ray (registered trademark) disk, other optical disk storage, a magnetic cassette, a magnetic tape, and a magnetic disk storage or other magnetic storage devices. The program may be transmitted on a transitory computer-readable medium or a communication medium. Examples of the transitory computer-readable medium or the communication medium include, but are not limited to, electrical, optical, acoustic, or other forms of propagating signals.

What is claimed is:

1. A relay server coupled to a first printing service system and a second printing service system that is coupled to an image forming device, the relay server comprising:
an authentication controller configured to acquire authentication completion information indicating that the first printing service system completes authentication for user authentication information input to a terminal device;
a printing controller configured to acquire user information from the first printing service system based on the authentication completion information, acquire printing job information corresponding to the user information from the first printing service system, and transmit, to the second printing service system, a request to cause the image forming device to execute printing for the printing job information;
a storage configured to acquire job state information corresponding to the printing job information from the second printing service system, and store printing history information corresponding to the job state information; and
a printing history information acquisition unit configured to acquire printing history information on the image forming device from the storage, wherein
the printing history information includes external user information that is information on a user belonging to an organization different from an organization to which the image forming device belongs.

2. The relay server according to claim 1, wherein
when receiving a printing history information request to request the printing history information from a first management device, the authentication controller acquires organization identification information from the first printing service system based on the printing history information request, and
the printing history information acquisition unit acquires printing history information on an image forming device corresponding to the organization identification information.

3. The relay server according to claim 1, wherein
the relay server transmits setting screen information for setting provision of personal information used for authentication of the user to a second management device, and receives provision setting information input to the second management device.

4. The relay server according to claim 1, wherein
the relay server sets request information to be requested from an external user when the external user uses the image forming device, and determines, based on the request information, information to be provided by the external user.

5. The relay server according to claim 4, wherein
the relay server permits printing using the image forming device when the information to be provided by the external user and determined based on the request information is provided by the external user.

6. The relay server according to claim 4, wherein
the relay server transmits setting screen information for setting the request information to a first management device, and receives the request information input to the first management device.

7. The relay server according to claim 4, wherein
when the external user does not provide the information to be provided by the external user and determined based on the request information, the relay server transmits, to the terminal device, information indicating that printing using the image forming device is not permitted.

8. The relay server according to claim 4, wherein
when the information to be provided by the external user and determined based on the request information is included in information that is provided by the external user, the relay server transmits, to the terminal device, a screen inquiring whether to provide the information that is provided by the external user.

9. The relay server according to claim 1, wherein
when receiving a printing history information request to request the printing history information from a first management device, the relay server transmits the printing history information to the first management device.

10. The relay server according to claim 1, wherein
when receiving a printing history information request to request the printing history information from a cost settlement device, the relay server transmits the printing history information to the cost settlement device.

11. The relay server according to claim 1, wherein
the relay server extracts printing history information on an external user from the printing history information, and calculates, based on the extracted printing history information on the external user, a printing cost for which the external user is charged.

12. The relay server according to claim 1, wherein
the relay server acquires the printing history information on the image forming device from the storage in response to a request from an administrator who manages the image forming device.

13. The relay server according to claim 1, wherein
the relay server is provided in the second printing service system.

14. A printing system comprising:
a first printing service system;
an image forming device;
a second printing service system coupled to the image forming device; and
a relay server coupled to the first printing service system and the second printing service system, wherein
the relay server includes
an authentication controller configured to acquire authentication completion information indicating that the first printing service system completes authentication for user authentication information input to a terminal device,
a printing controller configured to acquire user information from the first printing service system based on the authentication completion information, acquire printing job information corresponding to the user information from the first printing service system, and transmit, to the second printing service system, a request to cause the image forming device to execute printing for the printing job information,
a storage configured to acquire job state information corresponding to the printing job information from the second printing service system, and store printing history information corresponding to the job state information, and
a printing history information acquisition unit configured to acquire the printing history information on the image forming device from the storage, and
the printing history information includes external user information that is information on a user belonging to an organization different from an organization to which the image forming device belongs.

15. An information processing method performed by a relay server coupled to a first printing service system and a second printing service system that is coupled to an image forming device, the method comprising:
an authentication control step of acquiring authentication completion information indicating that the first printing service system completes authentication for user authentication information input to a terminal device;
a printing control step of acquiring user information from the first printing service system based on the authentication completion information, acquiring printing job information corresponding to the user information from the first printing service system, and transmitting, to the second printing service system, a request to cause the image forming device to execute printing for the printing job information;
a storage step of acquiring job state information corresponding to the printing job information from the second printing service system, and storing printing history information corresponding to the job state information; and
a printing history information acquisition step of acquiring the stored printing history information on the image forming device, wherein
the printing history information includes external user information that is information on a user belonging to an organization different from an organization to which the image forming device belongs.

16. A non-transitory computer-readable storage medium storing a program, the program causes a computer in a relay server coupled to a first printing service system and a second printing service system that is coupled to an image forming device to execute steps comprising:
an authentication control step of acquiring authentication completion information indicating that the first printing service system completes authentication for user authentication information input to a terminal device;
a printing control step of acquiring user information from the first printing service system based on the authentication completion information, acquiring printing job information corresponding to the user information from the first printing service system, and transmitting, to the second printing service system, a request to cause the image forming device to execute printing for the printing job information;
a storage step of acquiring job state information corresponding to the printing job information from the second printing service system, and storing printing history information corresponding to the job state information; and
a printing history information acquisition step of acquiring the stored printing history information on the image forming device, wherein
the printing history information includes external user information that is information on a user belonging to a second organization different from a first organization to which the image forming device belongs.
